(19) United States
(12) Patent Application Publication
(10) Pub. No.: US 2009/0276233 A1
(43) Pub. Date: Nov. 5, 2009

(54) COMPUTERIZED CREDIBILITY SCORING

(76) Inventors: Jeffrey L. Brimhall, Salt Lake City, UT (US); Jeff Madison, South Jordan, UT (US)

Correspondence Address: Workman Nydegger;1000 Eagle Gate Tower, 60 East South Temple, Salt Lake City, UT, 84111, US

(21) Appl. No.: 12/115,343

(22) Filed: May 5, 2008

(51) Int. Cl. G06Q 99/00

(52) U.S. Cl. 705/1

(57) ABSTRACT

A credibility engine creates individual credibility scores and network credibility scores that are distinguished from purely economic credit scores and which can be used to objectively rate a comparative value of credibility for entities and entity networks. The credibility engine analyzes credibility related information obtained from information providers and calculates corresponding credibility scores that are provided to information requesters. Some of the credibility related information used to create the credibility scores is obtained from surveys or reviews provided to primary and secondary sources having corresponding primary and secondary relationships with the entity. The entity can be an individual or organization.

### BACKGROUND OF THE INVENTION

1. The Field of the Invention

The present invention is generally related to embodiments for developing, using and accessing credibility scores, rankings and other indicators to reflect a measure of credibility.

2. The Relevant Technology

Credibility is an admirable characteristic that can be concisely defined, at least by some, as the quality of being believable or trustworthy. However, credibility is intrinsically tied to many other principles, including integrity, accountability, sincerity, reliability, as well as many other valued principles, and in such a way that the actual foundation and definition of credibility extends well beyond the limited description of being merely believable or trustworthy.

While the exact scope and definition of credibility can be difficult to precisely define, it is well-known that significant efforts are expended during many hiring processes in an attempt to identify candidates possessing attributes related to credibility. Constraints on time and resources, however, can often prevent an employer from being able to fully investigate or verify assumptions that are initially made during the interview process regarding a candidates' credibility.

Similar problems are also experienced by venture firms and angel investors who spend significant efforts in deciding whether to invest money in a particular project or person. Investors, like employers, want to invest in companies and individuals that possess the valued attributes that are related to credibility. Possession of these attributes, however, can be difficult to determine and can be even more difficult to verify.

### BRIEF SUMMARY OF THE INVENTION

The present invention provides various methods, systems and computer program products that can be used to determine, comparatively measure and verify the credibility of one or more individuals or other entities. Embodiments of the invention also extend to methods and systems for reputation scoring, as well as other attribute scoring.

According to some embodiments, credibility scoring and ranking is performed with objective processes and in such a way as to qualify and quantify what could otherwise be considered merely subjective analysis and input.

A credibility standard is established and a credibility engine obtains information related to the credibility of one or more entities. In some instances, these referenced entities are individual members subscribing to a credibility service provider. Entities can also include organizations, businesses, or groupings of individual people. The credibility engine analyzes the credibility related information and provides a corresponding individual credibility score for each entity being analyzed.

According to one embodiment, an entity can also obtain a related network credibility score that corresponds directly to a network of members associated with that entity. The network credibility score can include, for example, a combination of credibility scores of all the vetted or associated members that are included within a particular entity's credibility network.

The credibility scores, and other related credibility rankings and measures, can be dynamically adjusted over time to account for any new and updated credibility related information and analysis. The credibility scores, rankings and other indicators can also be provided, as desired, to any interested party according to any established criteria.

According to yet another embodiment, an employer or other interested party can query a database containing the credibility metrics of subscribing members, who have all been evaluated and scored, to identify one or more individuals that have credibility scores and attributes that match or that appear the closest to matching a predetermined credibility profile defined by the interested party. This can be done, for example, by creating and using a customized credibility scoring algorithm or by tuning an existing algorithm.

Employers and other interested parties can also tune or create customized credibility scoring algorithms by selecting the criteria to be considered in the algorithm and by tuning the weighting that is assigned to the selected criteria within the credibility scoring algorithm. By doing this, a customized scoring algorithm will be provided that can effectively filter and rank the pool of candidates being scored and in such a way as to identify the specific individuals that appear to most closely align with the selected and tuned criteria defined by the customized credibility scoring algorithm.

The foregoing Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of a computing network environment that includes a credibility engine and in which certain embodiments of the invention may be practiced;

FIG. 2A illustrates one embodiment of a circular graphic which includes various credibility related components;

FIG. 2B illustrates another embodiment of a circular graphic which includes various primary and secondary relationships;

FIG. 3 illustrates one embodiment of a SWOT matrix that comparatively graphs various attributes as strengths, weaknesses, opportunities and threats;

FIG. 4A illustrates one embodiment of a hierarchical credibility structure that includes various levels and requirements for advancement to the various levels;

FIG. 4B illustrates another embodiment of a hierarchical credibility structure that includes various levels and requirements for advancement to the various levels;

FIG. 5 illustrates one embodiment of a structure for a credibility scoring algorithm in which different types of credibility points are awarded, weighted and/or discounted in obtaining a final credibility score;

FIG. 6A illustrates one example of the application of a credibility scoring algorithm having a structure similar to the structure described in FIG. 5;

FIG. 6B illustrates another example of the utilization of a credibility scoring algorithm having a structure similar to the structure described in FIG. 5 and as modified by at least the implementations of the structure illustrated in FIG. 4B;

FIG. 7 illustrates an organizational graphic of two credibility networks and the various members linked together within the credibility networks;

FIG. 8 illustrates a graphical representation of credibility related information as defined by a relationship between the corresponding risk and data associated with the credibility related information;

FIG. 9 illustrates a pyramidal chart of certain credibility related components;

FIG. 10 illustrates a flow diagram of elements related to embodiments for developing and modifying individual credibility score;

FIG. 11 illustrates a flow diagram of elements related to embodiments for developing and modifying network credibility scores;

FIG. 12 illustrates a flow diagram of elements related to embodiments for using credibility information and networks

FIG. 13 illustrates one embodiment of a user interface configured for receiving credibility related information about a particular entity;

FIG. 14 illustrates one embodiment of a user interface configured for displaying credibility related information about a particular entity;

FIG. 15 illustrates a flow diagram of elements related to embodiments for calculating a score of a review or survey; and

FIG. 16 illustrates a flow diagram of elements related to embodiments for calculating a credibility score.

### DETAILED DESCRIPTION OF THE PREFERRED EMBODIMENTS

As indicated above, the present invention is generally related to embodiments associated with credibility scoring, reputation scoring and other attribute scoring. Accordingly, embodiments of the invention include, among other things, methods, systems and software for developing, verifying, modifying and using scores, rankings and other indicators that are related to measurements of credibility, reputation and other attributes.

The definitions for certain terms will now be provided in an attempt to provide context for the claims and embodiments that are disclosed herein.

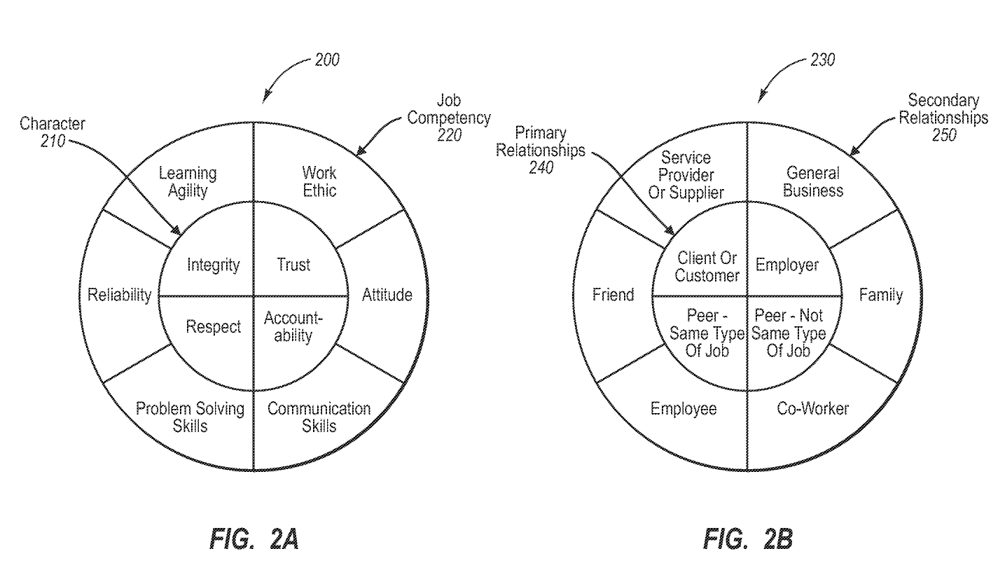

The term “credibility” is broadly defined as an attribute or characteristic of being believable or trustworthy and possessing other attributes and characteristics associated with credibility, including, but not limited to integrity, accountability, sincerity, reliability and respect. Other attributes and characteristics associated with credibility are described in more detail below with reference to FIG. 2A.

The term “credibility score” is an objective value corresponding to a perceived credibility. The credibility score is a scaled numeric value, according to some embodiments, that corresponds to a base value or within a range of values and in such a way as that the credibility score can be used to reflect a comparative credibility with respect to a base credibility score or the credibility scores of others. Similarly, the term “reputation score” is an objective value corresponding to a perceived reputation. The reputation score is a scaled numeric value, according to some embodiments, that corresponds to a base value or within a range of values and in such a way as that the reputation score can be used to reflect a comparative credibility with respect to a base reputation score or the reputation scores of others.

The credibility scoring algorithm used to calculate the credibility score can consider many attributes. According to one embodiment, however, the credibility scoring does not include financial attributes, and such that the credibility scoring algorithm omits or disregards financial histories, financial transactions and other financial considerations that are typically related to traditional credit scoring.

While many of the disclosed embodiments are specifically directed to credibility scoring, it will be appreciated that the invention also extends to other types of scoring, such as reputation scoring or other attribute scoring. Reputation attributes can be scored, for example, by tuning the credibility scoring algorithms in such a way as to more heavily weight or exclusively consider the reputation attributes present in the inventive scoring algorithms. Similarly, other attribute scoring methods can be realized by customizing the inventive scoring algorithms to more heavily weight or to exclusively consider any combination of specified attributes of interest.

Accordingly, it will be appreciated that the principles of the invention that appear directly related to credibility scoring can also be applied to reputation scoring, through the modification of only the weighting and consideration of the attributes that are included in the credibility scoring algorithm.

Inasmuch as many different attributes can be scored according to the present invention and inasmuch as the specific definition and scope of credibility is somewhat difficult to identify, it will be appreciated that the references, examples and claims that are recited herein, with specific regard to credibility scoring, can also apply to reputation scoring, as well as other types of attribute scoring. Accordingly, the term “credibility” should be interpreted extremely broadly, even to include the defined scope of reputation and other attributes, unless said “credibility” is more narrowly defined by the claims to omit consideration of reputation or any other specific attributes.

With specific regard to credibility scores, it will be noted that there are two basic categories of credibility scores described herein, including individual credibility scores and network credibility scores. Individual credibility scores generally relate to the credibility of a single entity, even if that entity includes a business, organization or other defined grouping of more than one person. Whereas, the network credibility score generally relates to the collective credibility of two or more entities that are associated within a network of entities.

In some embodiments, the terms “credibility” and “credibility score” are also associated with other types of measurements, besides numeric values, such as the disclosed credibility status, rankings, certifications and/or levels of hierarchical credibility structures.

The term “information provider”, which is an entity that provides information related to credibility about a particular member, is sometimes used interchangeably with the term respondent when the information provider is providing information in response to a specific request, such as a request to complete a survey or review, for example, as described in more detail below. The term “survey” and “review” are also used interchangeably. The term “assessment” is also sometimes used interchangeably with the terms “survey” and “review”, all of which are attribute evaluation tools.

The terms “entity” and member, which are also used interchangeably at times, generally refer to person, business or organization.

### Computing Environment

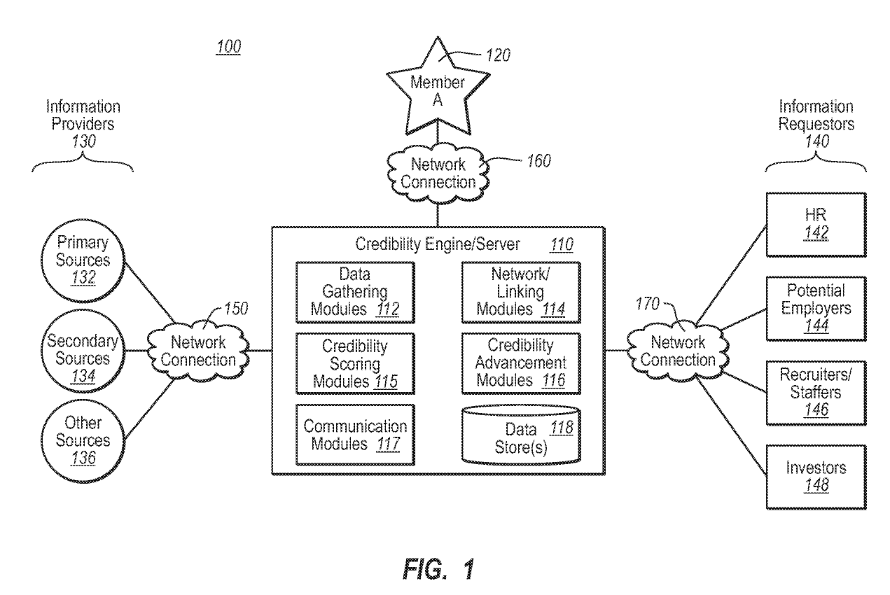

Many of the described and claimed embodiments utilize or comprise a computing system, such as a special purpose or general-purpose computer, including various corresponding computer hardware and software, as discussed in greater detail below in reference to FIG. 1.

It will be noted that the term “software” refers to computer-executable instructions or modules that are contained in one or more computer-readable media.

Such computer-readable media can include storage media and transmission media, as long as they can be accessed by a general purpose or special purpose computer. By way of example, and not limitation, computer-readable storage media can comprise RAM, ROM, EEPROM, CD-ROM or other optical disk storage, magnetic disk storage or other magnetic storage devices, or any other storage medium which can be used to carry and store desired program code means in the form of stored computer-executable instructions or data structures and which can be accessed by a general purpose or special purpose computer.

Transmission media includes wireless network connections over which the computer-executable instructions can be transmitted. Accordingly, when information is transferred or provided over a wireless network or communications connection, that connection is viewed as a computer-readable transmission medium.

The computer-executable instructions stored or carried by the computer-readable media comprise modules or instructions and data which cause a general purpose computer, special purpose computer, or special purpose processing device to perform a certain function or group of functions, such as those described within this application or to create a physical transformation of data that is contained in or that is accessed by the computing systems described herein.

### Credibility Engine

Attention is now directed to FIG. 1, which illustrates one embodiment of a computing environment 100 that can be used for practicing certain aspects of the invention. As shown, a credibility engine 110 or server, which includes various computing modules (112, 114, 115, 116 and 117) and data store(s) 118, is connected through one or more network connection(s) 150, 160 and 170, such as the Internet and/or another network connection, to one or more network entities (e.g., Member A 120, information providers 130 and information requestors 140).

It will be appreciated that while the credibility engine 110 can be contained within and comprise a single and discrete computing device/server, as shown, the credibility engine 110 can also be distributed throughout a plurality of distinct and connected computing systems, such as, for example, within a distributed computer network.

Furthermore, inasmuch as the network entities, identified as member A 120, information providers 130 and information requestors 140, can each comprise one or more humans, businesses or organizations, it will be appreciated that the connections between the network entities and the credibility engine 110 may actually be indirect connections. Accordingly, while the network entities are illustrates as being directly connected to the credibility engine 110, these network entities may actually be connected only indirectly to the credibility engine 110 through one or more corresponding computing systems or devices that each include corresponding hardware and software necessary to facilitate the connection and functionality described herein.

It will also be appreciated that while the modules (112, 114, 115, 116 and 117) and data store(s) 118 of the credibility engine 110 are shown as discrete and self-contained elements, each of the illustrated modules (112, 114, 115, 116 and 117) and data store(s) 118 can actually be combined or included in any combination and number of disparate and/or connected computing components that are local to the credibility engine 110 and/or remotely located from the credibility engine 110.

By way of example, the data store(s) element 118 (which can include any combination of volatile and non-volatile memory) is illustrated as a single storage database contained locally within the structure of the credibility engine 110. However, the data store(s) 118 can actually include a plurality of disparate databases and memory, any combination of which are located locally, as well as remotely, from the credibility engine 110, and which are functionally accessible to the credibility engine 110 through communications module 117. The same is also true of the various modules (112, 114, 115, 116 and 117), each of which are stored within the data store(s) 118.

The functionality of modules (112, 114, 115, 116 and 117) will now be described with additional detail and with specific reference to the credibility engine 110 and the network entities (i.e., member A 120, information providers 130 and the information requestors 140.

Initially, it will be noted that each of the illustrated modules (112, 114, 115, 116 and 117) contain sufficient computer-executable instructions for implementing the corresponding functionality described for each module, as well as any additional functionality required to implement the methods of the invention.

The data gathering modules 112, for example, comprise computer-executable instructions for identifying, gathering or otherwise obtaining credibility related information. The information related to credibility can be any information used by the credibility engine 110 to compute or otherwise identify a credibility score.

In some embodiments, the credibility related information comprises survey, review and evaluation data. The survey, review and evaluation data can be obtained, for example, by providing one or more questions to an information provider 130 and by receiving the corresponding feedback from the information provider 130. Typically, the survey, review or evaluation data is received from primary 132 or secondary 134 sources that have a preexisting relationship with an entity being evaluated and in response to sending a survey, a review or questionnaire to the information provider(s) 130. Examples of primary 132 and secondary 134 sources are described in more detail below, in reference to FIG. 2B.

Even though it is anticipated that most of the credibility related information will come from primary 132 or secondary 134 sources having a preexisting relationship with the entity being evaluated, it will be appreciated that in some instances, the credibility related information can also be obtained from other sources 136 that do not already have a preexisting relationship with the entity. Various different sources and networks can be mined for survey/review data. These sources include social networks, email databases, wireless network databases, and Internet address databases. Independent clearinghouses, government agencies and investigative organizations can also be queried or commissioned for credibility related information regarding a particular entity, such as Member A 120.

In some instances, the information providers 130 provide credibility related information only upon request. In other instances, the information providers 130 provide credibility related information voluntarily, without a specific request for the information that is provided, such as, for example, by providing the credibility related information on an accessible database or by pushing it to the credibility engine/server 110.

The credibility information provided to the data gathering modules 112 can include data that is presented in both paper and electronic formats. When data is presented in a paper format, the data gathering modules 112 include sufficient computer-executable instructions for scanning and interpreting the data from the paper format and for transforming the data into a digital format. When data is contained in an electronic format, the data gathering modules 112 include sufficient computer-executable instructions for parsing and transforming the data into a desired format and for storing the data in one or more of the data store(s) 118. This can also include embodiments in which the data is received telephonically and by converting the data that is presented by voice; or a touch tone or other telephone signal, into a digital representation of the data. In some instances, this also involves the use of voice interpretation software modules.

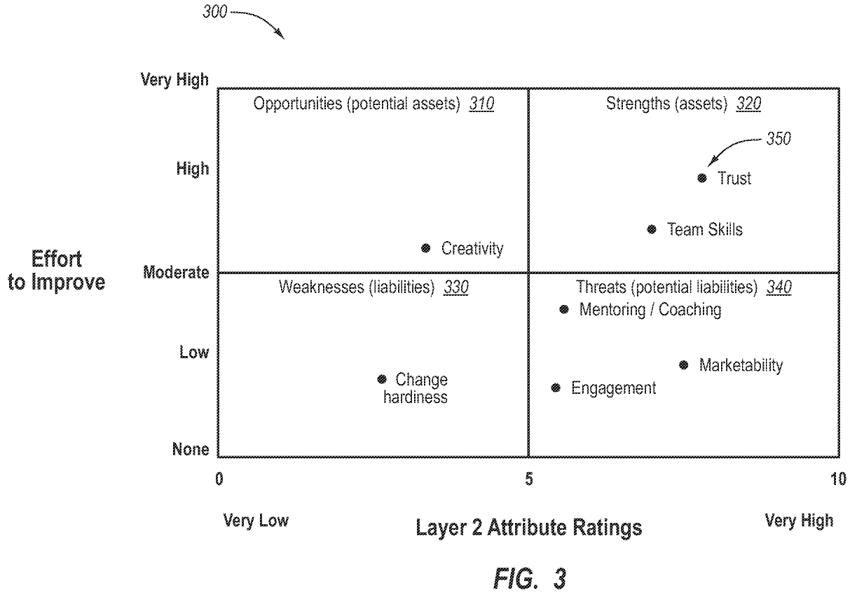

The network/linking modules 114 also comprise suitable interfaces and code for tracking and recognizing relationships existing between an entity, such as member A 120, and one or more other members, such as illustrated in FIG. 3, for example.

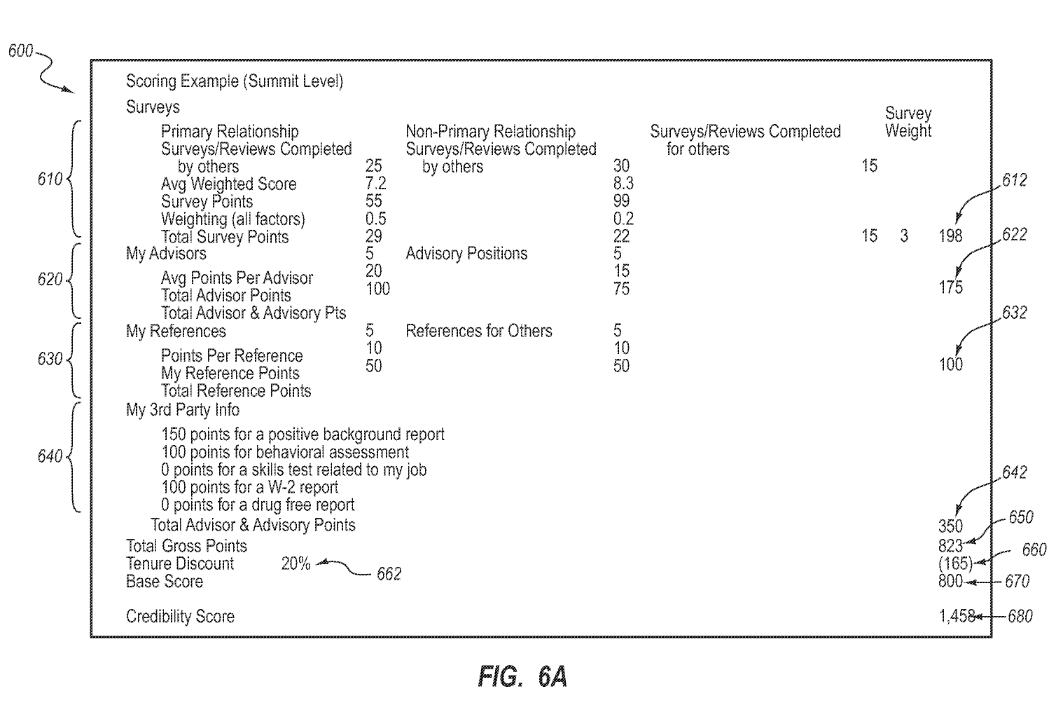

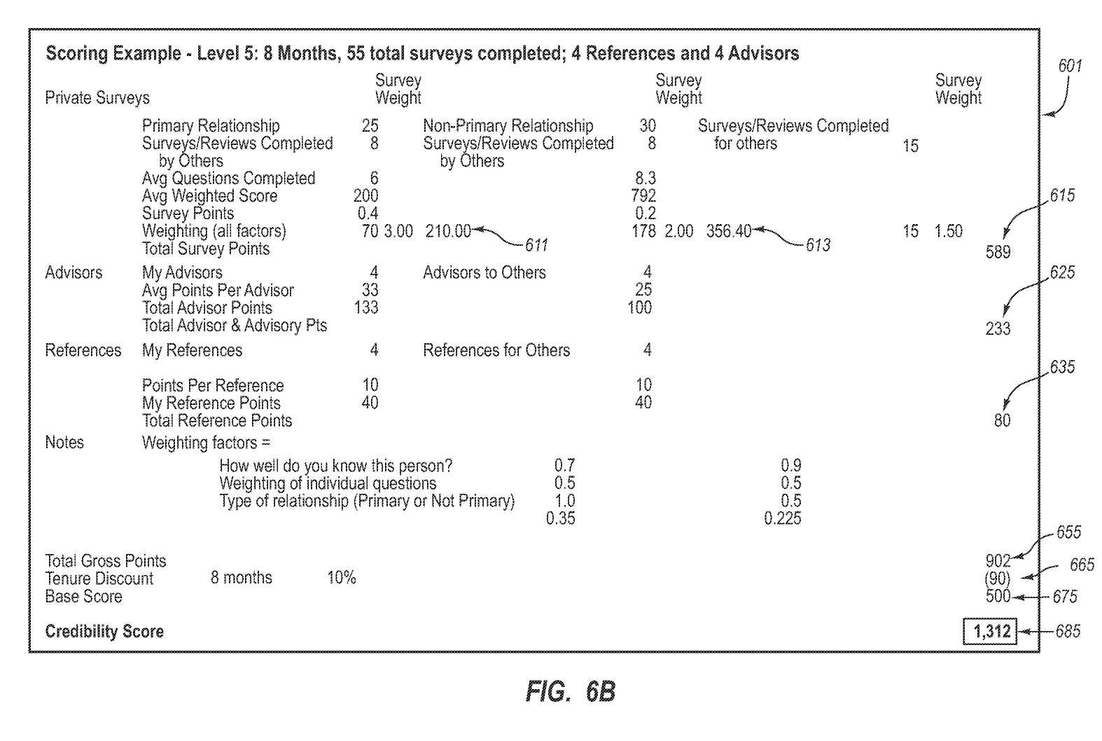

The network/linking modules 114 also track and recognize relationships between the entity and one or more information providers 130 and information requestors 140. This is useful to facilitate the gathering and dissemination of credibility related information to appropriate parties. In this regard, it will also be noted that any entity may fill the roll of a member, an information provider 130 and an information requestor 140. In fact, it is also possible for an entity to fill multiple rolls. For instance, entities can fill the roll of Member A 120, as well as the roll of an information provider 130 and/or and information requester 140, for themselves and for another entities, as should become more apparent in view of the disclosure provided in reference to FIGS. 6-8.

The credibility scoring modules 115 comprise suitable code and interfaces for receiving and analyzing the credibility related information and for calculating or otherwise developing individual credibility scores, as well as for calculating or otherwise developing corresponding network credibility scores. In this regard, it will be noted that the credibility scoring modules 115 also include sufficient code and interfaces for creating and identifying credibility standards against which the credibility scores are applied to provide a comparative measure of credibility.

The credibility scoring modules 115 also include functionality for enabling clients to selectively tune, include and/or exclude the specific criteria being analyzed in the credibility scoring algorithm(s) and so as to effectively define the scope of the credibility scoring standards being applied in any particular situation. This is useful, for example, in some embodiments, to obtain a reputation score or another customized attribute score.

The credibility advancement modules 116 are also configured to create, customize and identify credibility standards and to reflect corresponding credibility measures.

While the credibility scoring modules 115 are directed primarily to the analysis of numeric credibility scores and values, the credibility advancement modules 116 are directed primarily to the analysis of non-numeric credibility values, such as credibility rankings, credibility levels or other credibility status indicators. Accordingly, the credibility advancement modules 116 are also configured to recognize and track the status and advancement of an entity as the entity progresses through the various rankings or levels of a hierarchical credibility standard. The credibility advancement modules 116 also track and monitor the requirements and an entity's completion of requirements corresponding to the entity's advancement through the hierarchically structured credibility standards.

The credibility scores and measures that are obtained through the credibility scoring and advancement modules (115, 116) can be provided to any appropriate information requestor 140. Some examples of information requestors include human resources 142, potential employers 144, recruiters/staffers 146 and investors 148. As suggested above, it is possible that the entity being scored, such as member A 120, or an information provider 130 can also be the information requestor 140. Other types of information requesters 140 can also exist, including government agencies and information clearinghouses.

The credibility related information, including credibility scores, are provided to the information requesters 140 in any desired format and in according to any desired criteria, so as to accommodate different needs and preferences. In some instances, the credibility scores and information are only provided to an information requestor 140 upon demand. In other instances the credibility information is voluntarily pushed to an information requestor 140 as a service. The service may be subscribed for at a fee or may be provided free of charge.

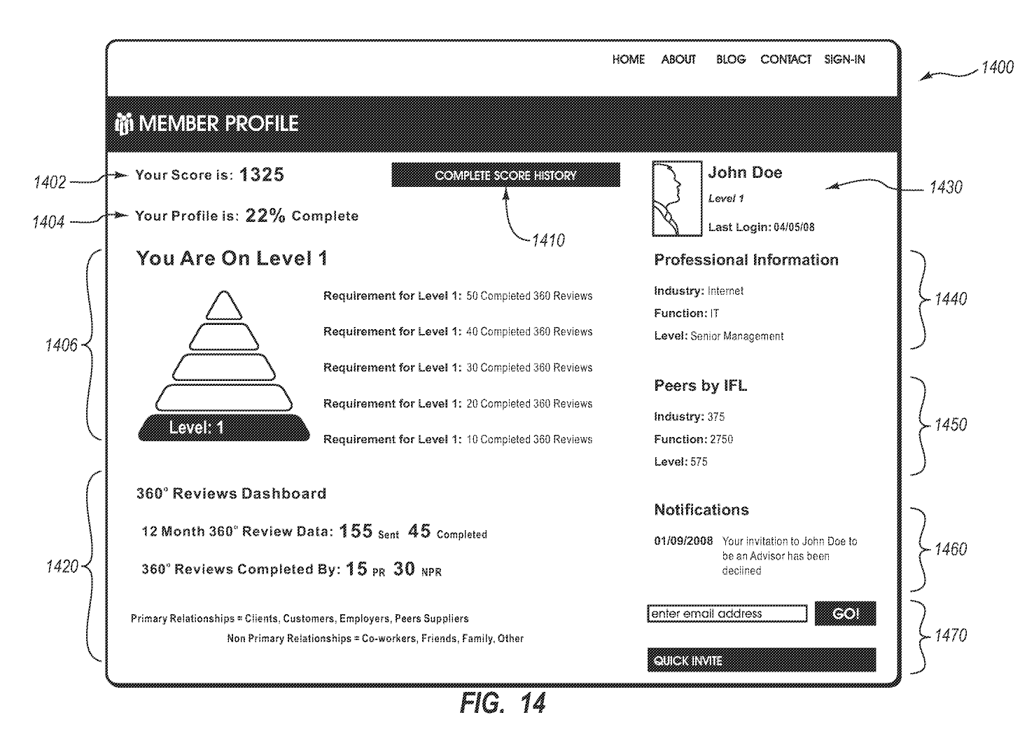

When the credibility information and scores are provided in an electronic format, they are sometimes accessed through a Web-based interface, such as interface 1400 shown in FIG. 14. The interface is configured, in some instances, to require login and password information associated with a subscribing member prior to providing information. In this manner, the credibility scores and information can be maintained confidentially.

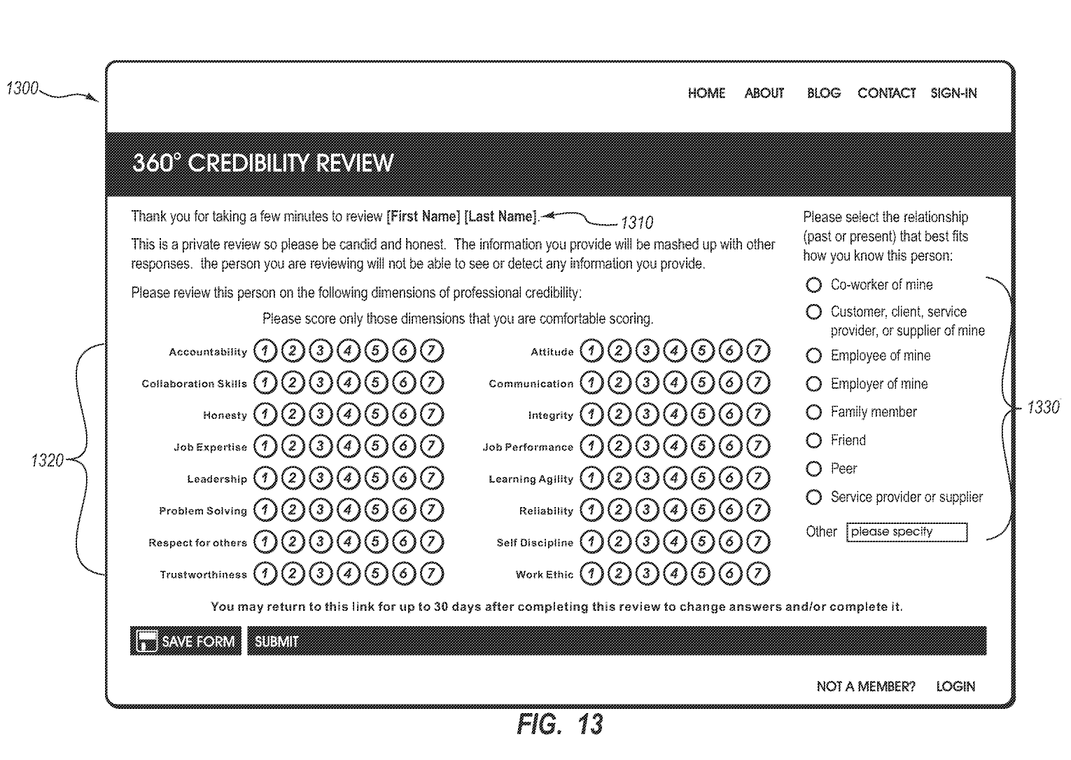

It will be appreciated that Web-based interfaces, such as interface 1300 of FIG. 13, can also be used to obtain information from the information providers 130. For example, surveys can be completed with or at least submitted through the Web-based interface. In some instances, the surveys include reviews, such as the 360 reviews described in more detail below.

The same or different Web-based interface can also be used as a home portal for an entity, such as member A 120, to manage and monitor their own credibility scores and other related credibility information, such as their credibility ranking and status and credibility network(s). The Web-based interface can also be used by members to communicate with other members, including references and advisors, as well as information requesters and other information providers, as will be apparent from the disclosure provided below.

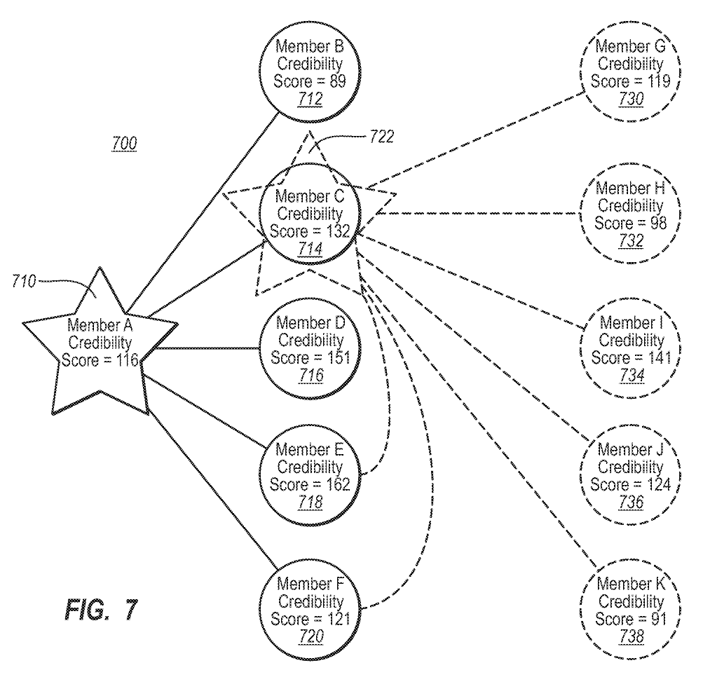

Through the interface, for example, Member A 120 can identify other members to be included in Member A's credibility network (see FIG. 7, for example) and/or to request inclusion into another credibility network. Member A 120 can also use the interface to identify references, advisors or other contacts having a preexisting relationship with member A 120, and which may be willing to complete a survey, a review or to provide other credibility related information. See element 1470 of FIG. 14, for example. The interface can also be used to identify information requesters 140 that the member's credibility scores should be sent to. See element 1460 of FIG. 14, for example.

All of the foregoing interfaces, as well as any other interface used to facilitate the functionality described herein, are generally provided by the communication modules 117, which generally enable the data gathering modules 112 to request and obtain or provide credibility related information through the network connections 150, 160 and 170. The communication modules 117 also facilitate and enable the communication of credibility related information through paper mail and telephonic communications and other communication channels that are not necessarily considered traditional computer network connections.

Finally, it will be appreciated that the communication modules 117 also include suitable code and interfaces for enabling all of the various modules of the credibility engine 110 to dynamically communicate and access and publish the credibility related information.

As mentioned above, all of the various modules (112, 114, 115, 116 and 117) are stored within the data store(s) 118 of the credibility engine 110. The credibility engine 110 also stores the credibility related information received from the information providers, such as survey and review data, as well as the credibility scoring algorithms and scores corresponding to a credibility analysis. The data store(s) 118 can comprise any combination of volatile and non-volatile memory.

Attention will now be directed to FIG. 2A, which comprises a graphic 200 of various credibility related attributes and characteristics. There are two circles included in the graphic 200, an inner circle 210 comprising character attributes and an outer circle 220 comprising competence attributes. These groupings (210, 220) of attributes generally correspond with two of the basic elements of professional credibility, namely, character and competence.

As reflected in FIG. 2A, credibility attributes related to an entity's character are grouped into grouping 210, including the credibility related attributes of integrity, trust, respect, and accountability. Other credibility attributes related to competency are grouped together into grouping 220, including the attributes of work ethic, attitude, communication and problem solving skills, reliability and learning agility.

Besides merely identifying different credibility attributes, the groupings of FIG. 2A (210, 220) are useful insomuch as they also reflect a relationship and potential value of credibility related information as applied to a credibility score. In particular, credibility information relating specifically to the character attributes of grouping 210 will be weighted more heavily, in some instances, than the credibility related information corresponding to the attributes of competency found in the secondary/outer grouping 220. It will be appreciated, however, that different and alternative groupings can also exist and that the weighting of the various credibility related attributes can vary to accommodate any need or preference for characterizing and weighting credibility attributes. It will also be appreciated that the attributes reflected in the graphic 200 of FIG. 2A are not intended to be an exhaustive list of all attributes that correspond to credibility. Accordingly, in other embodiments, different combinations and quantities of attributes are considered. In fact, it will be appreciated, for example, that the listing of mapped attributes can correspond more exactly with the attributes listed in the 360 Review™ described below in the Survey and Review description.

For convenience, groupings 210 and 220 have also been created, according to one embodiment, to correspond directly to groupings of potential sources of credibility related information. For example, groupings 210 and 220 correspond directly with groupings 240 and 250 of graphic 230 in FIG. 2B, and as described in more detail below.

With specific reference to FIG. 2B, it will be noted that groupings 240 and 250 identify and define the scope of potential relationships that people, businesses, or organizations might have with a particular entity.

The primary relationship grouping 240 includes various entities (e.g., clients/customers, employers and peers of the same or different jobs) that can be viewed as primary sources (see element 132 of FIG. 1). Similarly, the secondary relationship grouping 250 includes various entities (e.g., businesses, family members, co-workers, employees, friends and suppliers) that can be viewed as secondary sources (see element 134 of FIG. 2). It will be appreciated, however, that the illustrated groupings are not intended to be mutually exclusive. Accordingly, in some instances, it is possible for a single person or entity to assume multiple relationship rolls with a member, as generally described above, and such that a secondary source having a secondary relationship with an entity can also comprise a primary source having a primary relationship with the same entity.

As suggested above, graphic 230 can also be viewed as generally corresponding with graphic 220. In particular, the entities referenced within the primary relationship grouping 240 can be viewed as primary source information providers for the credibility related information corresponding directly to the character attribute grouping 210 of FIG. 2A. Similarly, the entities referenced within the secondary relationship grouping 250 can be viewed as secondary source information providers for the credibility related information corresponding directly to the competency grouping 220 of FIG. 2A.

It will be appreciated that various different types of groupings and designations can also be tracked and defined as primary or secondary sources. In some embodiments, additional contextual information is required to define the term of a relationship or to further define the location, quality or other context of a relationship to determine how much weight a relationship will be given in the scoring algorithms described below.

In some instances, the primary source information providers are termed references and/or advisors within a hierarchical credibility structure. Additional detail regarding the roles of the references and advisors will be provided in more detail below.

### Surveys and Reviews

It will be appreciated that various surveys, reviews and questionnaires can be created and provided to those that are identified within the primary and secondary relationship groupings in order to query for and obtain information related to the credibility of a particular entity. The surveys and reviews are standardized according to some embodiments. According to other embodiments, the surveys and reviews are customized for particular types of information providers depending on the nature of their relationship with the entity being evaluated.

Some non-limiting examples of survey and review questions that can be used to obtain credibility related information and to identify potential relationships of information providers with an evaluated entity are provided below within the following Survey Table.

With specific regard to the foregoing Survey Table, it will be appreciated that other types of surveys and survey questions can also be used, even those that are specifically tailored to a particular type of entity being evaluated or to accommodate a particular credibility standard. For example, different surveys can be created to obtain different information for different entities and according to the different requirements for different credibility rankings, certifications or standards. Accordingly, in some embodiments, a member may have to first specify what type of credibility ranking/certification is being requested in order to identify an appropriate set of survey questions to consider for distribution and analysis.

Different questions can also be provided to focus on different attributes that are more related to an individual's reputation, for example.

Another example of a survey or review, called a 360° Review™, is provided in the following 360° Review™.

### 360° Review™:

Thank you for taking a few minutes to review [First Name] [Last Name].

This is a private review so please be candid and honest. The information you provide will be mashed up with other responses. The person you are reviewing will not be able to see or detect any information you provide.

Please review this person on the following dimensions of professional credibility: (1=little to none at all) (7=extremely high)

| | | | | | | | |
|---|---|---|---|---|---|---|---|
| Accountability | 1 | 2 | 3 | 4 | 5 | 6 | 7 |
| Attitude | 1 | 2 | 3 | 4 | 5 | 6 | 7 |
| Collaboration Skills | 1 | 2 | 3 | 4 | 5 | 6 | 7 |
| Communication Skills | 1 | 2 | 3 | 4 | 5 | 6 | 7 |
| Honesty | 1 | 2 | 3 | 4 | 5 | 6 | 7 |
| Integrity | 1 | 2 | 3 | 4 | 5 | 6 | 7 |
| Job Expertise | 1 | 2 | 3 | 4 | 5 | 6 | 7 |
| Job Performance | 1 | 2 | 3 | 4 | 5 | 6 | 7 |
| Leadership | 1 | 2 | 3 | 4 | 5 | 6 | 7 |
| Learning Agility | 1 | 2 | 3 | 4 | 5 | 6 | 7 |
| Problem Solving Ability | 1 | 2 | 3 | 4 | 5 | 6 | 7 |
| Reliability | 1 | 2 | 3 | 4 | 5 | 6 | 7 |
| Respect for others | 1 | 2 | 3 | 4 | 5 | 6 | 7 |
| Self Discipline | 1 | 2 | 3 | 4 | 5 | 6 | 7 |
| Trustworthiness | 1 | 2 | 3 | 4 | 5 | 6 | 7 |
| Work Ethic | 1 | 2 | 3 | 4 | 5 | 6 | 7 |

Select the relationship (past/present) that best fits how you know this person:
Co-worker of mine [Not Primary]
Customer, client, service provider, or supplier of mine [Contextual information required; see below]
Employee of mine [Contextual information required; see below]
Employer of mine [Contextual information required; see below]
Family member [Not Primary]
Friend [Not Primary]
Peer [Contextual information required; see below]
Service provider or supplier [Contextual information required; see below]
Other—please specify [Not Primary]
(You may return to this review (link provided here) for up to 30 days after completing this review to change answers and/or complete it.)

In one embodiment, the foregoing 360° Review™ is also provided with additional information, such as definitions for each of the various attributes being rated. When the 360° Review™ is provided online, a user interface enables the definition to be displayed for each attribute when a user hovers a mouse prompt over a bubble associated with the attribute, hovers a mouse prompt over the name of the attribute, or accesses a definition option on a displayed menu. Some examples of the definitions that can be provided and displayed include the following 360° Review™ definitions:
Accountability (This individual has a willingness to accept responsibility for their own actions and decisions.)
Attitude (This individual has a positive attitude and creates positive energy with others)
Collaboration Skills (This individual includes and engages others to solve problems and get things done.)
Communication Skills (This individual possesses verbal and written skills, demonstrates good grammar and vocabulary, asks good questions, and is an active listener.)
Honesty (This individual is truthful, upright and willing to admit their mistakes)
Integrity (This individual adheres to moral and ethical principles and acts consistently and fairly.)
Job Expertise (This individual has extensive job know-how, skills and abilities.)
Job Performance (This individual meets or exceeds the requirements and demands of their job.)
Leadership (This individual demonstrates the ability to effectively lead others.)
Learning Agility (This individual learns, thinks and adapts quickly, and takes initiative to self-develop.)
Problem Solving Ability (This individual effectively solves problems at work and in life.)
Reliability (This individual is dependable and responsive; their work, feedback and communication are accurate, complete and on time.)
Respect for others (This individual shows regard and consideration for others.)
Trustworthiness (This individual always acts in my best interests and in the best interests of others.)
Work Ethic (This individual is hard working, diligent, determined to accomplish and takes initiative.)

Various other information and questions can also be provided with the 360° Review™. For example, various contextual information can be queried for, including the following contextual information:

Contextual Information (additional information for primary relationships)
Employee of mine (past or present)
   From ______ to ______
   Company ______
Employer of mine (past or present)
   From ______ to ______
   Company ______
Peer
   We're peers because (check all that apply)
      We're in the same industry ______
      We have the same job function ______
      We have the same job level ______
      We attend the same school ______
      Other (specify) ______
Service provider or supplier of mine; customer or client of mine (past or present)
   From ______ to ______
   Company ______

According to one embodiment of the invention, a plurality of different surveys and reviews are provided for analyzing different attributes and for obtaining different attribute scores. For example, one survey or review will be customized for analysis of credibility. Another survey or review will be customized for analysis of reputation, and yet other surveys and reviews are customized for analysis of other attributes.

In some embodiments, a client or information requestor can also select and/or build custom surveys and reviews for a particular need. For example, an information requestor can view a list of attributes and select which of the attributes are to be presented or questioned about. Alternatively, or in combination, the information requestor can assign different weights to the different attributes that are presented and analyzed in the final scoring of the credibility, reputation or other attribute(s).

Preferably, although not necessarily, the surveys and reviews are completed in an anonymous manner, so that the person completing the survey or review can feel comfortable being completely honest in their answers. Various different sources and networks can be mined for survey/review data. These sources include social networks, email databases, wireless network databases, and Internet address databases.

The results of the surveys and reviews can be weighted according to a relationship the person completing the survey has with the individual being analyzed (e.g., primary relationship vs. secondary relationship) and so as to normalize the effect of potential bias. Different types of primary and secondary relationships can all be associated with different weightings.

As mentioned above, surveys and reviews can be completed and submitted anonymously. Alternatively, or in combination, some of the surveys and reviews can also be submitted in a transparent manner. For example, according to one embodiment, a standard respondent will provide completed surveys or reviews in an anonymous fashion, while a vetted or other reference or advisor of the present system will provide completed results that are transparent and not anonymous.

Surveys and reviews that are anonymous are sometimes referred to herein as Layer 1 Surveys or Reviews. Surveys and reviews that are transparent, on the other hand, are sometimes referred to herein as Layer 2 Surveys, Reviews or Assessments. Yet additional evaluation tools, referred to herein as Layer 3 Surveys or Evaluations provide anonymous and/or transparent commentary and evaluations regarding a member's publications.

### Assessments

According to one embodiment, the information gathering process involves gathering a plurality of completed anonymous surveys, as well as transparent assessments. The assessments can generally be thought of as a transparent type of survey. The assessments will typically be completed by other members (e.g., references and advisors) who are attempting to advance their own credibility by completing requirements necessary to become advisors and/or to otherwise advance through the hierarchical rankings of the credibility structure(s) described below in more detail.

While some assessments can be completed by member references or other information providers, in one embodiment, it is preferred that the assessments be provided only by advisors or references, who are known and established (vetted) within the credibility network and that have achieved minimum requirements within the credibility network. It is also preferred that the anonymous surveys or reviews be completed by other information providers that have not yet completed the more stringent requirements that are required to become a vetted reference or advisor within the credibility network.

The transparent surveys, reviews or assessments (namely the Layer 2 Assessments) that are completed by the references or advisors can be the same as the anonymous surveys or reviews, only in this case they will not be anonymous. Alternatively, the assessments can provide different types of questions or word the questions differently than they were presented in the anonymous surveys or reviews.

One example of a different or additional question that can be asked in an assessment includes a follow-up question that queries for a perceived desire or effort to improve. This type of question, which can be presented after every other question in the survey, review or assessment, can be particularly helpful in completing a SWOT matrix, such as the SWOT matrix shown in FIG. 3, corresponding to the Strengths, Weaknesses, Opportunities and Threats identified from the completed assessment(s) and that specifically correspond to a selected set of attributes related to credibility.

It is preferable, although not necessary, that the questions are presented within the assessments in such a way that the feedback or answers to the questions can be objectively and quantifiably mapped or graphed within a scale or graphic, such as a SWOT matrix or another graphic that will be helpful in enabling a member to see the relative perception of their various attributes.

The SWOT matrix 300 of FIG. 3 illustrates one example of a graphic that can be used for quantifying or evaluating the relative perception of attributes related to an individuals potential assets (defined as opportunities) (310), assets (defined as strengths) (320), liabilities (defined as weaknesses) (330), and potential liabilities (defined as threats) (340). This SWOT matrix 300 can be used to graph virtually any attributes related to credibility, including, but not limited to the attributes listed in Survey Table I, the 360° Review™, as well as any other selected attributes.

As shown, the SWOT matrix 300 of FIG. 3 is one example of a completed SWOT. In particular, the SWOT matrix 300 graphically reflects whether certain selected attributes (trust, team skills, creativity, mentoring/coaching, marketability, engagement, and change hardiness) of an individual are perceived as strengths, weaknesses, opportunities, or threats. The SWOT matrix 300 also provides a relative measure of the various attributes of the member (at least as perceived by one or more evaluators). Although it is not always the case, the results of a Layer 2 Assessment will typically be presented in a SWOT matrix.

To help clarify how attributes of a member can be graphed into a SWOT matrix, such as the SWOT matrix 300 of FIG. 3, attention will now be specifically directed to the graphically illustrated measure of the trust attribute 350. In this non-limiting example, a member's trust attribute is evaluated from the feedback received in a single assessment that asks how trustworthy the member is perceived by a particular advisor that is completing the assessment, as well as how diligently the member is perceived by the advisor in trying to improve their trustworthiness. The intersection of the feedback from the advisor (comprising a 7.5/10 for perceived trust and a High rating for effort to improve) results in the placement of the trust attribute 350 on the SWOT matrix 300 in the location where it is illustrated.

It will be appreciated that the feedback from various different types and combinations of questions can be considered in the determination as to what rating and placement an attribute will have within a SWOT matrix. The SWOT score or measure of any particular attribute can also be a combined or weighted average based on the quantity of feedback, the relationship of the entity providing the feedback with the member that is being evaluated, the age of the feedback, the perceived validity of the feedback, and so forth.

According to one embodiment, advisors, references and other information sources are presented with a computerized interface in which they complete survey questions with numeric responses or answers, such as, for example, as presented within the Survey Table or 360° Review™, illustrated above. The data obtained from these surveys, reviews and assessments can then be weighted and graphed into the SWOT matrix.

In another embodiment, an interface is provided that enables an advisor, reference or other information source to directly graph certain attributes of a member into the SWOT matrix. This can be done, for example, by enabling an evaluator to drag and drop icons that represent the various attributes onto the SWOT matrix, or by simply moving icons that are already presented in the SWOT matrix to their appropriately locations (as determined by the evaluator), or by clicking on the location within the SWOT matrix where a particular attribute should be reflected (as determined by the evaluator). Alternatively, or additionally, numeric values can be provided in an interface that causes a graphical representation of a specific attribute to be automatically calculated and displayed in an appropriate location on the SWOT matrix.

Preferably, although not necessarily, the SWOT matrix results are transparent to at least the individual members so that they can see how they are evaluated and perceived by others (e.g., references, advisors). Although some evaluators may be hesitant to provide feedback with this desired transparency, an appropriate motivation can be created to provide the necessary incentive to get a desired level of honest feedback by compensating the evaluator for their feedback. The compensation can include, for example, financial compensation and/or credibility bonus points that enable the evaluator to obtain a higher credibility score. Alternatively, or additionally, the completion of a predetermined number of SWOT assessments may also be required prior to a reference or advisor advancing to a next level within the hierarchical credibility structure, or to maintain an existing level.

### Level 3 Evaluations

The Level 3 Evaluations represent a peer-to-peer review of publications and other works or creations that are not considered typical publications. In one embodiment, a member publishes a work or presents their work in a medium that can be searched and accessed through the Internet, for example. Preferably, the member will provide a link to their work with one of the interfaces provided by the credibility engine/server described above and so that the link to their work (or the actual work itself) can be pushed to one or more network peers (e.g., references, advisors, other members of the network).

Any type of publication can be evaluated and reported on as third party reports (950). Some non-limiting examples of publications that can be evaluated and reported on include books, Wikipedia articles, YouTube videos and other videos, news articles, blog postings, patents, press releases, book reviews, downloadable songs, and so forth. The third party reports can be stored by the credibility engine to provide a corpus of new searchable digital content that can be used to provide scores and subjective feedback. The third party reports can be provided with or without a specific request for the reports.

According to one embodiment, the network peers will also provide commentary regarding the work that is being evaluated and which can be viewed by the member, so that the member can see how their work is perceived by their peers. This feedback can be provided through the interfaces of the present invention and/or through email or any other communication means.

The peers can also rate or score the work, based on a predetermined scale and based on any predetermined set of scoring criteria, including, but not limited to criteria such as originality, accuracy, precision, technicality, artistry, persuasiveness, and so forth. In some embodiments, a panel, board or committee made up of qualified members performs the evaluation and scoring of the member's work. The third party reports can also include detailed information and/or simple ratings, such as thumbs up and thumbs down ratings, star or point ratings, or any other ratings.

Providing a specific panel of member judges or evaluators can be particularly helpful to remove some of the subjective disparity that can occur between different peers. Different panels of judges can also be provided to judge only the specific and respective types of work in which they are qualified as specialists.

### Hierarchical Credibility Structure

As suggested in some of the disclosure provided above, the hierarchical structure of the credibility network of the present invention enables individuals to further distinguish themselves and to promote themselves as being credible. The credibility structure of the present invention also enables the credibility of members to be repeatedly verified and established, such as, for example, by requiring the completion of numerous surveys, reviews and assessments related to the evaluation of the members.

Some examples of different credibility standards and hierarchical structures or rankings will now be provided, in which a member is able to reach a particular credibility level or certification upon completing certain requirements. For example, according to one embodiment a member only reaches a first level upon having a minimum number of surveys or reviews completed about them. Requirements to reach a particular level can also be dependent upon receiving surveys or reviews from a certain number of references, advisors or other respondents considered to be primary sources.

A member may also be required to complete a certain number of surveys, reviews or assessments or to be a reference or advisor for a predetermined number of other members (and/or to provide/receive a certain number of evaluations) prior to advancing in credibility rank within the credibility structure.

According to one alternative embodiment, certain credibility levels or rankings may also require that a member establish a credibility network that includes a plurality of other members. Examples of credibility networks are described below in reference to FIGS. 7 & 11.

Advancement to a particular level can also require that certain additional or 3^{rd} party data has been obtained or completed, including assessments, 3^{rd} party information, member profile data (940), and other data (950)(as reflected by the graphic of FIG. 9 and as described in more detail below). Any combination of the foregoing can also be imposed as a requirement for achieving or advancing past a certain credibility ranking/level or certification.

One non-limiting example of different requirements that may be required to advance between levels is illustrated in the following Credibility Camp Table that lists credibility levels or rankings as “camps” along with the corresponding requirements to advance into each camp.

Credibility Camp Table:

| | Surveys, Reviews or | |
|---|---|---|
| | Assessments | |
| | Completed | Networked |
| Credibility Camp | about Entity | Members |
| Base Camp/Level | 25 | |
| Camp/Level 1 | 50 | 1 |
| Camp/Level 2 | 75 | 5 |
| Camp/Level 3 | 75 | 10 |
| Camp/Level 4 | 75 | 15 |
| Summit | 75 | 20 |
| Camp/Level | | |

In addition to any of the foregoing requirements, a member can also be required, in some instances, to have completed surveys or reviews received from a predetermined set of the primary and secondary sources (generally shown in FIG. 2B) prior to advancing between camps or levels. By way of example, a member may have been required to have had surveys or reviews received from at least 3 of the 4 primary sources (having a primary relationship with the member) as identified within grouping 240 of FIG. 2B and/or from any predetermined number of secondary sources as identified within grouping 250 of FIG. 2B.

The member can also be required to complete additional profile data and to have had additional 3^{rd} party information (930) received about the member before any advancement can be made from any stage in advancement. Some examples of 3^{rd} party information include skills tests, background reports, behavioral assessments, w-2 compensation reports, FICO or other credit scores, aggregation data from sites such as (TrustPlus, Repptide, Rapleaf, TheGorb, and so forth).

A member may also be required to complete detailed profile data (920) and to provide additional data. One example of some other information (950) that the member may have to provide includes personal publication materials.

In view of the foregoing, it is clear that the requirements for advancing in credibility ranking or credibility certification will become more stringent for each stage of advancement. This is intentional and is clearly reflected by the graphic in FIG. 9. The actual requirements for each advancement, however, can be altered as desired, to accommodate any need or preference.

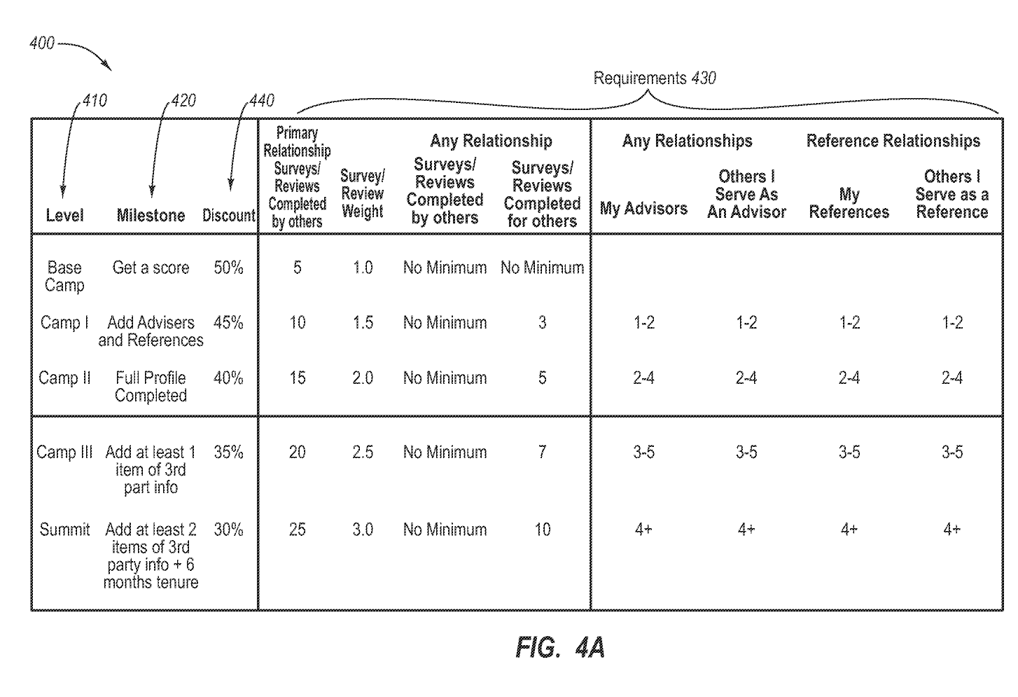

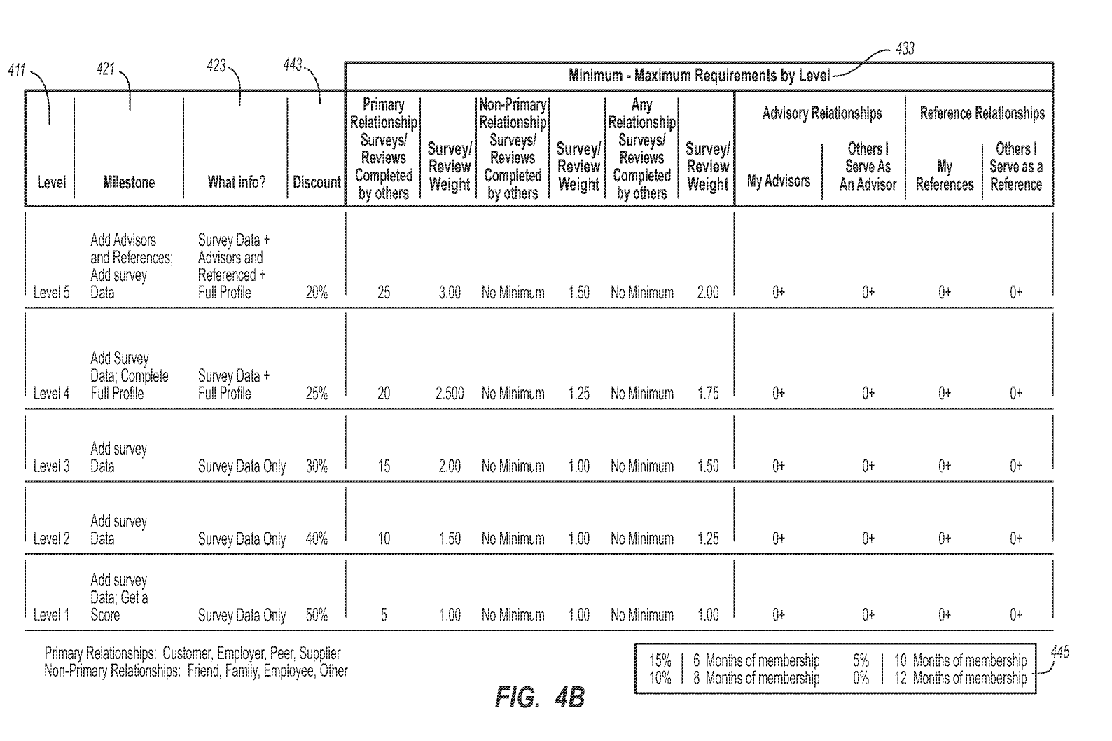

Another example of a hierarchical structure or camp table, along with the corresponding requirements for advancing between the different credibility levels or camps, will now be provided with reference to FIG. 4A.

As shown in FIG. 4A, a hierarchical structure 400 includes various levels 410 that a member can advance to as part of their measured credibility. In this example shown in FIG. 4A, the levels include a Base Camp level, a Camp I level, a Camp II level, a Camp III level and a Camp IV level which is also referred to as a Summit level. Each of these levels or camps is associated with different milestones 420 that a member receives or provides. For example, in Base Camp a member receives a credibility score. In Camp I the member adds advisors and references, and so forth.

To advance from one level or camp to the next, a member must comply with certain requirements. In the present example, the requirements 430 for advancement include obtaining a predetermined number of surveys or reviews to be completed by others, including a predetermined number of surveys or reviews to be completed by others who have a primary relationship with the member (see FIG. 2B and the corresponding disclosure, for example, regarding the definition of a primary relationship). The requirements also specify a minimum number of surveys or reviews to be completed by the member for others. As farther illustrated, advancement between levels can also be contingent upon a member having a minimum number of advisors and references associated with the member, as well as a minimum number of relationships in which the member serves as a reference or advisor to other members.

With regard to the foregoing, it will be appreciated that various different and other criteria can also be established for advancing between levels of a credibility hierarchical structure. It will also be appreciated that various different requirements may be established for defining the roles of an advisor or reference.

### REFERENCES

According to the present invention, a “reference” or “credibility reference” is another credibility network member that knows the individual they are serving as a reference for and they are also vetted by the credibility standards established by the credibility network. Preferably the reference is also someone that generally trusts the member and that the member also trusts. Additional requirements for being a vetted reference include joining the credibility network, getting a credibility score, verifying the member's public profile, completing a Layer 1 Survey or Review (an anonymous survey/review) about at least the member, and complete a Layer 2 Assessment (a SWOT-type assessment or survey/review that is transparent to the member being evaluated). In compensation for their efforts and compliance with the reference requirements, the reference will receive credibility points and the satisfaction of knowing that they are helping the member to improve their credibility. The reference can also advance towards completion of a qualification requirement for certain credibility rankings, such as the requirement that a member become a reference for a certain number of other members.

### Advisors

While a member can fill the role of both a reference an advisor, it is noted that the specific qualifications to become a vetted advisor are greater than the requirements to become a reference. In particular, an advisor must comply with all of the requirements to become a reference, as well as some additional requirements. Some of the additional requirements include committing to share advice when it is requested by the advisee, and introduction of the advisee to the advisors private credibility network (such as, but not limited to the types of private credibility networks described below in reference to FIGS. 7 and 11). The advisor also commits to sharing information that can help the advisee to improve. Members will be willing to comply with these requirements in compensation for advancement in their own credibility ranking and scores, as well as for the satisfaction of watching others they care about improve their own credibility rankings and scores.

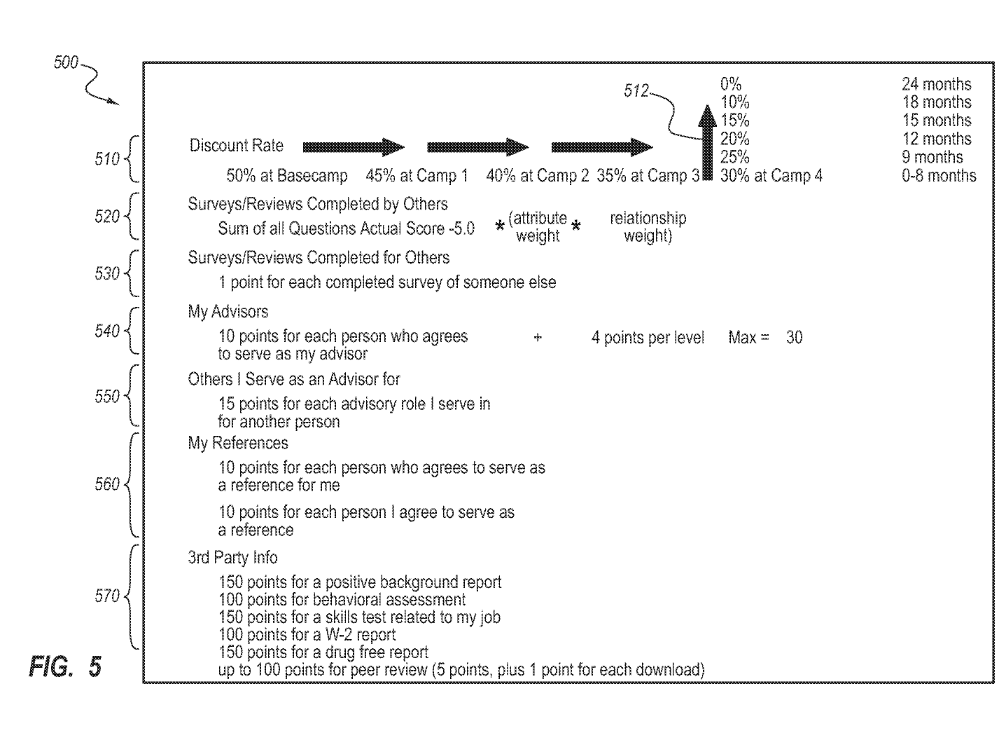

As a final note with regard to FIG. 4A, before advancing to FIG. 5, it is noted that the various levels 410 of the hierarchical structure 400 are associated with different discount percentages 440. These discounts 440, are functionally provided according to the present invention to weight the credibility scores of a member in a manner that is commensurate with their advancement through the credibility ranks. The weighting of the surveys/reviews will also vary, in some embodiments, depending on the status of the member. For example, the weighting of surveys/reviews will be greater for members who have achieved the Summit level (e.g., a 3.0 weighting) than for members who have only achieved a level less than a Summit level. The foregoing will become more apparent with the examples that are provided with reference to FIGS. 5 and 6.

### Credibility Scoring Algorithm

Attention will now be directed to FIG. 5 which illustrates the structure 500 of one credibility scoring algorithm of the present invention. As shown, various different factors or elements are considered as part of the credibility scoring algorithm. These factors include the camp/level discount rate element 510, the tenure discount rate 512, which were referenced above, survey/review elements 520 and 530, advisors elements 530 and 540, reference elements 560 and 3^{rd} party information elements 570. Each of the foregoing elements will now be described in more detail.

Initially, it is noted that the discount rate element 510 includes a plurality of different discount rates that are presented as percentages. These percentages or discount rates reflect the amount in which a member's preliminary credibility score will be discounted. Accordingly, a member's credibility score will be discounted by 50% if they are only qualified at the Base Camp level. Whereas, the same member will only have their preliminary credibility score discounted by 35% if they are qualified at the Camp 3 level.

While most of the discount rates are static, it will be appreciated that some of the discount rates can also be dynamically affected by time or other factors. For example, arrow 512 reflects a dynamic tenure discount rate that is inversely proportional with the passage of time. In particular, the discount rate of the Summit Level, which is also known as the Camp 4 level according to the present embodiment, will change with the passage of time. Even more particularly, the discount rate of 30% will be applied to the preliminary credibility score of a member who has been a member less than nine months. As the member maintains their standing over time, the tenure discount rate applied to their preliminary credibility score will continue to be decreased by a predetermined amount. For example, the tenure discount rate will decrease to only 20% if the member maintains their Camp 4/Summit Level ranking for between 12 months and 15 months.

Time discounts can also apply to the scoring data as well. For example, survey/review data scores can be discounted based on their age, such that newer survey/review data is given more weight than older survey/review data. In one embodiment, the SWOTS, peer rankings, survey/review data and other rating/scoring data is not discounted at all if it is newer than about 12 months. However, after about 12 months (or another predetermined period of time), the scoring data begins to lose its value over time until it has little or no value after about 24 months (or another second predetermined period of time). Accordingly, in this manner, a member who achieves a very high score, but fails to obtain new surveys/reviews and other scoring data will actually lose much of their previously earned credibility score.

It will also be noted that the survey/review elements include a consideration of both the surveys/reviews completed by others about the member (520), as well as the surveys/reviews completed by the member about others (530).

The value of points associated with the surveys/reviews completed by others can be an average value of points obtained from all respondents. While the survey/review points can vary, between survey types, in order to accommodate any number of questions and weights applied to the questions in the surveys/reviews, it will be appreciated that it is also possible to normalize or scale the average survey/review points into a predetermined range or predetermined scale, such as a scale of 0-100, 0-10, or any other scale. In other words, the sum of all points obtained from all questions in a completed survey/review can be rescaled into a revised sum out of a possible 100 points, for example. This is true, even when different questions are assigned different points and/or weights.

As reflected in the present embodiment, the original or rescaled sum of all questions (with each question being assigned a possible value) is reduced by a fixed amount, such as by a value of 5. This reduced sum is then multiplied by attribute weights, relationship weights and any other desired weights (with higher weight being applied to primary relationships than secondary relationships). According to some embodiments, different weights are applied to each of the different types of primary relationships and each of the different types of secondary relationships. Preferably, although not necessarily, the value of each of the various weights are percentages or calculated values within the range of 0-1.

Application of the different weights in the foregoing manner enables certain bias to be discounted, such as, for example, by those who might unfairly give the member too much credit for certain credibility attributes.

Additional weights can also be applied to consider the age of feedback (completed survey/review date) and the potential validity of the data. For example, discounting weights can be applied to discount the score or value of older data, based on the age of the data (e.g., by applying a smaller weight value for older data than newer data). Similarly, a validity weight can be applied to discount the value of data received from unreliable sources (e.g., brand new accounts, new email accounts used to send the data, and so forth).

The second survey/review element 530 corresponds to the number of surveys/reviews that have been completed for others. In the present embodiment a member gets one point for each survey/review completed for another member. The total number of earned points for surveys/reviews completed can be limited to a predetermined number or, alternatively, it can be unlimited to provide a continued inducement for evaluating and validating the credibility of others.

The advisor point element 540 corresponds directly to the number of people that a member can get to be their advisor. The total amount of points that can be earned through the advisor point element 540 can be limited or, alternatively, be unlimited to accommodate different needs and preferences. In the present example, the point total that can be earned through the first advisor point element 540 is 30 points. This point total includes 10 points for each advisor plus bonus points that are applied for the different levels of each advisor, which can be set to any amount to accommodate any need or preference.

There is a second advisor point element 550, through which a member can currently earn an unlimited number of points by becoming advisors to other members. In the present embodiment, for example, 15 points are awarded to the member for each person they serve as an advisor to.

Another unlimited point earning element is the references element 560. According to the present embodiment, a member earns 10 points for each person that qualifies as a vetted credibility reference for the member, as well as 10 points for each person that the member qualifies as a vetted reference for.

Lastly, the member can also obtain predetermined points for obtaining certain other 3^{rd} party information (570) that can be used to verify their credibility, including, but not limited to 150 points for obtaining a positive background report from a certified agency, 100 points for a completed behavior assessment from one or more predetermined sources, 150 points for completing a skills test related to the member's job and from a predetermined source, 100 points for a W-2 report or other financial verification report, and 150 points for a drug free report provided by a predetermined source.

Points can also be awarded for receiving feedback for peer review of published works, as described above in reference to the Level 3 Evaluations. In the present embodiment, for example, a member will receive 5 points for having a work reviewed by a peer, a panel, or another predetermined evaluation board. The member will also receive one point for each time their work is accessed or downloaded to award the member for the interest their work generates.

Despite the detail that has been provided in the foregoing examples, however, it will be appreciated that different point totals and weights can also be applied to the credibility algorithms of the invention and that different criteria can also be considered in obtaining a credibility score. It is envisioned, however, that most of the tuning to the credibility algorithm will come through the application of different survey/review questions and the application of different weights to the survey/review questions, as specified by different information requesters.

To further clarify how the foregoing credibility scoring algorithm can be applied an example of a member's individual credibility score will now be provided with reference to FIG. 6. FIG. 6 illustrates the credibility point totals corresponding to each of the credibility elements described in FIG. 5.

Initially, as shown in the survey/review point section 610, the member has had 55 surveys/reviews completed for the member, with 25 of those surveys/reviews being completed by others that are determined to have a primary relationship with the member and 30 by those that do not have a primary relationship with the member. In the present example, the survey/review points obtained from the surveys/reviews completed by those having a primary relationship with the member is 55 and 99 points were obtained from the surveys/reviews completed by those having a secondary relationship with the member. The 55 points was calculated by multiplying the total primary relationship surveys/reviews (25) by (2.2), which is the sum of the average weighted score of the primary relationship surveys/reviews (7.2) minus the normalizing value of 5. Similarly, the 99 points for the non-primary relationship surveys/reviews was calculated by multiplying the total non-primary relationship surveys/reviews (30) by (3.3), which is the sum of the average weighted score of the non-primary relationship surveys/reviews (8.3) minus the normalizing value of 5.

The average weighted scores of 7.2 and 8.3 were also calculated for the surveys/reviews from the primary and the non-primary relationship sources, respectively, by averaging the total survey points for each grouping of surveys/reviews. Additional weighting factors are also applied, based on type of relationships the survey review respondents have with the member being evaluated. In the present example, a weighting of all relationship factors for the primary relationship respondents is 0.5, while the weighting of all relationship factors for the non-primary relationship respondents is 0.2. The final survey/review point totals of 29 and 22 are then calculated by multiplying the preliminary survey/review point totals (55 and 99) by the corresponding weightings (0.5 and 0.2) for each of the primary and non-primary relationship survey/review tallies, respectively. 15 points are also awarded for the 15 surveys/reviews completed by the member for other members. Accordingly, the survey/review point total (612) awarded to the member is 198. The 198 survey/review point total is equal to 3 times 66, with 3 representing the Summit level weighting for survey/review points and with 66 representing the sum of the 29 primary relationship survey/review points, the 22 non-primary relationship survey/review points and the 15 points for completing surveys/reviews.

The advisor point section 620 shows that 5 people have agreed to be advisors for the member, corresponding with 100 total points earned from advisors. Each associated advisor is shown to correspond with an average of 20 points. 10 of those points for each advisor were awarded automatically. The other 10 points, per advisor on average, were awarded based on the level of the advisor (with 6 points being awarded for each level the advisor has achieved in the credibility network).

The advisor section 620 also reflects the 75 points earned by the member for qualifying as an advisor for 5 people. The advisor point total (622) is therefore 175 points (equal to the 100 points for the member's advisors plus the 75 points for serving as an advisor to others).

The references point section 630 reflects the 100 points earned as the reference point total (632). This total is the sum of the 50 points earned for the 5 references associated with the member (10 points for each), as well as the 50 points for the 5 people in which the member has qualified to be a reference for (10 points for each).

The 350 3^{rd} party point total (642), which is reflected in the 3^{rd} party information section 640, is the sum of the 150 points earned for a positive background report, 100 points earned for a completed behavioral assessment, and the 100 points earned for a supplied W-2 report. Currently, no points are awarded for peer review. However, in other embodiments, peer review points are awarded (as described above in reference to FIG. 5).

In view of the foregoing, the total preliminary credibility score (650) for the member is 823 points, which is the sum of the 198 points awarded for the survey/review point total (612), the 175 points awarded for the advisor point total (614), the 100 points awarded for the references point total (632) and the 350 points awarded for the 3^{rd} party point total (642).

In the present example, the member has been a Summit or Camp 4 member for a period of time between 12 months and 15 months, meaning that the member's 823 point preliminary credibility score (650) is subject to a 20% tenure discount of approximately 165 points (equal to 20% of 823 points).

Accordingly, after applying a normalizing base score (670) of 800 points to the preliminary credibility score (650) of 823, minus the tenure discount (660) of 165 points, the member's Final Credibility Score (680) is 1,458 points.

In view of the foregoing example, it will be appreciated that the final credibility score of any member can be comparatively evaluated against standards and the scores of other members to provide a relative measure of credibility. It will also be appreciated that the foregoing algorithm can be tuned and modified to consider and weight different attributes more or less significantly. Different normalizing scores (like the 800 in the present example) can also be applied to further accentuate or reduce the distinction created by any particular factor. In some embodiments, the tuning and calculation of the social computing algorithm is performed by a computing system.

It will be appreciated that, notwithstanding the specificity of the foregoing examples, the scope of the present invention also extends to other related embodiments, such as reflected in FIGS. 4B and 6B, as well as others.

FIGS. 4B and 6B are provided to illustrate one example of how the structures and social computing algorithms of the present invention can be tuned and adjusted to accommodate different needs and preferences.

In FIG. 4B, for example, a structure is provided that is very similar to the structure provided in FIG. 4A. However, in FIG. 4B the various levels are called levels (411) rather than camps. Each level is also associated with specific milestones 421 and discounts 443, similar to the milestones 420 and discounts 440 illustrated in FIG. 4A. However, the values of the level discounts (440 and 443) are not identical. Likewise, the tenure discounts 445 that are provided by the structure of FIG. 4B are different than those previously attributed to the structure of FIG. 4A through element 512 of FIG. 5.

Other changes include the addition of an information requirement 423, which specifies what type of information is required to advance through the different levels of the structure.

Finally, it is noted that the Minimum and Maximum requirements 433 for each level in FIG. 4B (allowing any number of advisory and reference relationships) are different than the corresponding Maximum and Minimum requirements illustrated in FIG. 4A.

By modifying the structure in the manner illustrated by FIG. 5, as well as by making a few other modifications, it is possible to obtain an entirely different type of scoring result, as illustrated by the example in FIG. 6B. Some of the other changes (corresponding specifically to FIG. 5, include the change in the tenure discount, the change in advisor points and a cancellation of the 3^{rd} party information points (570). The tenure discount (as applied to FIG. 6B and as changed from FIG. 5), includes applying a tenure discount of 15% for belonging to level 5 less than 6 months, a tenure discount of 10% for belonging to level 5 between 6-8 months, a tenure discount of 5% for belonging to level 5 between 8-10 months, and applying no tenure discount for belonging to level 5 over 12 months.

The changes in the advisor points (between FIG. 5 and the algorithm applied to the example of FIG. 6B) includes applying 25 points (instead of 15) for each advisory role the member serves and applying 8 points (instead of 4) for each level the advisors have that agree to serve as advisors to the member, as well as allowing a total of 50 advisor points (rather than 30) for having advisors.

According to example 601 in FIG. 6B, which relies on the foregoing changes discussed with regard to FIGS. 4B and 5, a member obtains a credibility score (685) of 1312.

Initially, it is noted that the credibility score (685) includes a weighted survey/review score 615, which includes a sum of a first weighted score (611), which is based on surveys/reviews completed by others having primary relationships with the member, and a second weighted score (613), which is based on surveys/reviews completed by others having primary relationships with the member. The weighted scores are also based on multiplying the initial survey/review points by predetermined weighting factors. In the present embodiment, primary relationship weighting factor comprises a value of 3 and the secondary or non-primary relationship weighting factor comprises a value of 2. Surveys/reviews completed by others (which are not defined as either primary or secondary/non-primary sources) are weighted by a third weighting factor of 1.5. It will be appreciated, however, that the value of these weighting factors can change to accommodate different needs and preferences.

The total weighted survey/review point value of 569 (615) is added to the total advisor point total of 233 (625), plus the reference point total of 80 (635), to arrive at a gross point total of 902 (655). A tenure discount of 10% is also applied, reducing the score by a tenure discount of 90 (665). However, a base score (675) of 500 is added to arrive at a total credibility score (685) of 1312.

Again, the foregoing example is merely illustrative of how the credibility and social computing algorithm can be applied to arrive at an objective credibility score that accounts for various subjective criteria that has been quantified through surveys/reviews and other scoring and organizational techniques.

### Interfaces

Once a member's credibility score is calculated, access to the credibility score can be provided through a computerized interface hosted by a credibility server or engine, such as the system described in reference to FIG. 1. Access can be limited or unlimited to any predetermined entities. For example, access to the credibility score can be limited to only the member or to any paying and/or authorized information requesters. Preferably, the credibility score and corresponding credibility information (e.g., survey/review results, peer reviews, and so forth) are provided and accessed through the various interfaces of the credibility engine.

The various interfaces of the credibility engine also enable members to manage their credibility rankings and personal credibility networks. In particular, the interfaces also allow members to identify and define the relationships that the members have with the specific information providers and information requestors, including the references and advisors in the member's credibility network. In some embodiments, the members also use the interfaces to provide the contact information for potential respondents (comprising potential information providers), which are to be supplied a survey/review, or survey/review questions or a published work, such as those described above, and which will be evaluated and/or completed by the respondent.

The contact information provided by the member can include an address (physical mailing address and/or email address) as well as a phone number or website (such as a personal page on Facebook, LinkedIn, Zoominfo, Spoke, MySpace or any other networking website).

Automated interfaces then use the contact information to provide the survey/review to the correspondingly identified information providers, such as, for example, as a hyperlink to the survey/review delivered through email. It will be appreciated that there are various types of survey/review methods, in addition to the various types of surveys, reviews or assessments, which can be delivered over the phone, through printed paper mail, through email and Web services. It will also be appreciated that the delivery of surveys/reviews can be automated or operator controlled. For example, surveys/reviews provided over the phone can be delivered through recordings or machine automated speech. Similarly, Web service surveys/reviews can be automated or controlled by a live operator/assistant who can request clarification or additional information when desired, through instant messaging and email technologies.

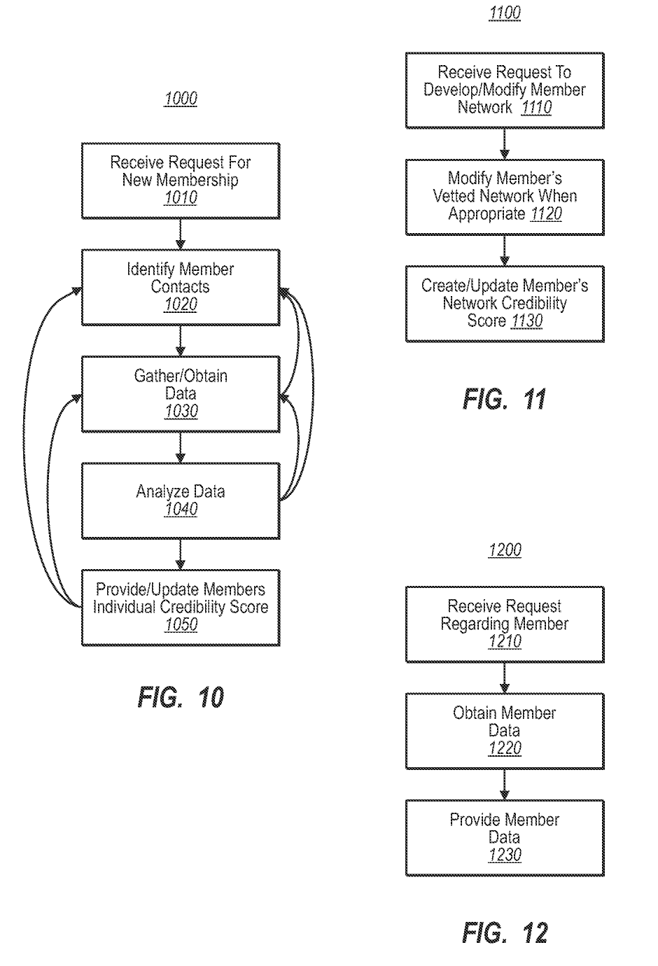

In addition to identifying the information providers, a member can also identify one or more other members to join in a credibility network, as reflected in FIG. 7, and as described in more detail below with reference to FIGS. 10-12. However, attention will first be directed to FIG. 4A, which is particularly relevant in view of the variety of delivery and retrieval means for obtaining credibility information and in view of the variety of different types of information providers.

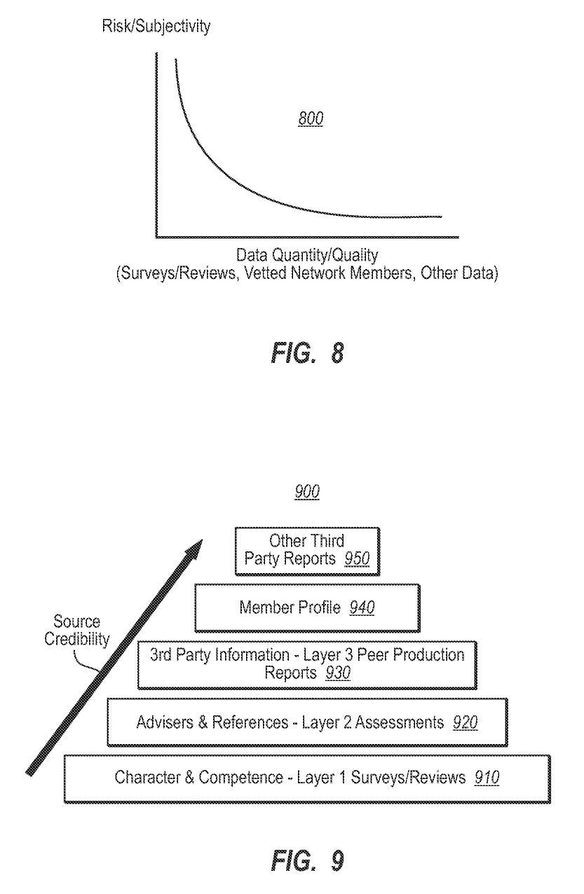

FIG. 8 illustrates a relationship that exists between the credibility related information that is gathered and the actual or at least perceived subjectivity of that information. As shown, the risk or the credibility related information being subjective or flawed is directly and inversely proportional to the amount of information received and the quantity and quality of information received. In particular, the risk of the credibility information being subjectively flawed will reduce as the quantity and quality of the information received increases.

To reduce the risk of subjectivity, certain requirements are put in place, according to some embodiments, to ensure that a sufficiently large sampling of information sources is obtained prior to providing a credibility score. For example, a minimum number of surveys/reviews can be required, according to some embodiments, prior to providing a credibility score for a particular entity. In other embodiments the subjectivity of the credibility score is controlled, at least in part, by controlling the quantity of information sources, such as, for example, by requiring input from certain primary sources and/or secondary sources or, alternatively, by restricting information received from certain sources.

The quality of the credibility related information can also be controlled, at least in part, by creating and providing specific and detailed survey/review questions that tend to be objective (such as questions that require a comparative or ranking type answer).

FIG. 9 illustrates another diagram 900 that reflects a credibility relationship. In particular, diagram 900 includes various credibility related components and credibility sources that are stacked together in such a way as to indicate the progression of an entity's credibility as well as the different types and sources of credibility information that is required to advance through some of the hierarchical credibility structures of the present invention. As indicated, the progression and development of an entity's credibility scores and ranking will increase, for example, as the member obtains additional information to verify the members character and competence (with layer 1 surveys/reviews, for example) (910), obtains advisers and references and layer 2 assessments (920), obtains 3^{rd} party information such as peer reviews/layer 3 reports (930), creates a detailed member profile (940) and obtains other information (950), such as the additional items that were referenced above in the 3^{rd} party information section 570 of FIG. 5as.

Attention is now directed to FIG. 10, which illustrates a flowchart 1000 of one embodiment for creating a credibility score or ranking. As shown, the process begins with the request for membership (1010). This request can be as simple as an entity requesting a credibility score for themselves or for any other party. The request can also include the registration and subscription for a credibility service. The request process 1010 will at least be involved and interactive enough to enable the credibility engine to identify contact information associated with the entity.

Next, the contacts associated with the member (the entity) are identified (1020). This can also be an interactive process and can occur over an extended period of time. As mentioned above with reference to FIGS. 2A-2B, this will typically involve the identification of contact information associated with information providers, as well as the identification of a relationship the member has with each of the information providers.

According to one embodiment, the member identifies their contacts directly from their email applications (e.g., Outlook, Gmail, etc.). Contacts can also be identified from Web networking cites, such as (Facebook, Myspace, etc.). Regardless of how the contacts are identified, the contact information for each of the contacts is preferably provided so that the credibility engine can contact the potential information provider.

The credibility engine obtains and gathers credibility related information from the information providers (1030) in any suitable manner. For example, this may include mailing, calling, emailing, instant messaging or contacting the information provider in some other way.

In some instances, the process of obtaining and gathering information also includes the processes of receiving and requesting information from a member directly. The member can also provide information voluntarily to the credibility engine, as can any of the information providers. In many instances, the process of obtaining and gathering information includes the creation, dissemination and retrieval of surveys/reviews, and corresponding survey/review data, as described above, including follow-up survey/review data.

The surveys/reviews, which are preferably comprised of short questions, can be transmitted in their entirety to a potential information source. Alternatively, a link to a survey/review can be transmitted via email or communicated in another way to a potential information source. Various tools can also be used, if desired, to verify that a survey/review respondent (information provider) is the actual respondent being queried, such as by requiring certain passwords or keywords that are provided to the respondent with the survey/review. When anonymity is important, tools can be used to verify completion of a survey/review by a particular respondent and without linking the completed data to the respondent. This can be done, for example, by extracting the data and storing the data separately from the data tracking which respondents have completed the surveys/reviews.

The surveys/reviews that are distributed and processed according to act 1030 can include anonymous surveys/reviews (such as the Layer 1 surveys/reviews) as well as the transparent surveys/reviews and assessments (such as the Layer 2 assessments). It will be appreciated that the selection of different types of surveys/reviews and corresponding questions is one way to tune the credibility scoring algorithms applied during analysis 1040 of the data. Weighting of different questions and answers during analysis of the received data is another way to tune the credibility scoring algorithm.

It will be appreciated that the data obtained 1030 and analyzed 1040 is not limited to survey/review data. In particular, the obtaining or gathering credibility information 1030 can also include obtaining 3^{rd} party information, such as the types of information referenced above in the 3^{rd} party information section 570 of FIG. 5. 3^{rd} party information can include, but is not limited to such things as criminal record reports, drug tests, litigation reports, education certifications, other certifications, skill tests (e.g., Previsor, Brainbench, etc.), and so forth.

The acts of gathering and obtaining the data can also include any processes required to record or format the data once it is received back from the respondent, including parsing (electronic data), scanning or manually entering data printed on paper, transcribing audio data, and any other such processes.

Preferably, the process of obtaining data through the surveys/reviews (at least Level 1 surveys/reviews) is performed anonymously, to encourage honest and relevant answers. Various interface tools can also operate as automated reminders to follow-up on distributed surveys/reviews until corresponding feedback is received or until a certain number of surveys/reviews have been completed.

The data that is finally obtained will be analyzed (1040) by the credibility engine. Analyzing the data includes determining relevance of the data. Analyzing the data can also include scoring and applying a value to any portion of the data (such as to a particular answer in a survey/review) and for weighting the data, depending on criteria such as the relationship of the source to the member, how well the source knows the member, relevance, timing, question importance, quality of descriptive data, quantity of data, and/or any combination of the above.

One example of weighting data includes weighting the scores to questions provided by respondents as follows: weighting values of questions from co-workers and employees with a 0.5 weighting, weighting values of questions from customers or clients, employers and peers with a 1.0 weighting, weighting values of questions from friends and family with a 0.25 weighting, weighting values of questions from business acquaintances (other than peers) with a 0.7 weighting.

Analyzing data can also include aging survey/review scores. For example, after a predetermined period of time, the corresponding survey/review data will be depreciated in value by a certain percentage every month or day. As one example of this, survey/review data that is over a year old will depreciate in value by 2.0% per month or 1/15% every day. This type of embodiment will encourage and promote the frequent updating of credibility information.

In some instances, analyzing data also includes interpreting or extracting a context of the data. Analyzing data (1040) can also include verifying data by comparing the data to other received data and to look for patterns or inconsistencies. In this regard, it will be appreciated that the weighting of the data can also be based on the presence of established patterns or inconsistencies. In some instances, analyzing data (1040) can also include ignoring certain data that is determined to be incorrect, irrelevant, too old, from a particular respondent or that is too prejudicial.

A final step to analyzing the data includes applying the various data scores and components to one or more ranking and scoring algorithms to arrive at a final credibility score. According to one embodiment, survey/review questions require a scaled value to be selected, such as a value within a scale from 1-5, 1-10, 1-100 or another scale. In such embodiments as this, each of the questions are weighted, as desired, and then normalized and/or applied to an algorithm.

According to some embodiments, various gaming rules and algorithms can also be applied to identify and ignore fraudulent or skewed answers and values. It is possible, for example, to discount the results received from sources that appear to be invalid, such as sources that have email accounts or other accounts that have just recently been created or when an unusually large amount of information is received from a plurality of unknown or unconfirmed sources in a short period of time corresponding to a particular member or when results from surveys/reviews appear too skewed. Other circumstances, such as the detections of email addresses that consistently rank a particular member high, can also reflect someone is trying to game the system. This is particularly true when the party doing the rating never joins the credibility network. Other anti-gaming techniques and measures can also be put in place.

When questions are not answered as a value within a range or a scale, it is up to the credibility engine to evaluate and score answers so as to provide an objective value that can be used to calculate the points that will be awarded for the perceived credibility of the member related to the answer that is given. This can be done automatically, relying on existing evaluation software (which extracts a context from text) and applies a score based on context. Alternatively, an operator or assistant can evaluate and score feedback received from information providers. According to one preferred embodiment, each question in a survey/review is measured on a 10 point scale. The score or points applied to each question is set equal to the value that is provided as an answer to the question (e.g., 1-10 or another scale) minus a fixed value (such as five or another value). For example, if a respondent indicated that a member ranked a six (out of a scale from 1-10) for reliability, the point total awarded to that respondent would be one after subtracting the fixed value of five. All of the points for the various questions in a survey/review can then weighted by a respondent's relationship with the member, based on how well the respondent knows the member and based on a perceived importance of the question, or based on any other predetermined criteria.

This embodiment is useful for identifying and applying positive feedback to increase a score and without necessarily damaging a score for negative feedback. In this manner, negative feedback is largely ignored. This also avoids the need of having every question answered in a survey/review and which can be useful when certain questions are inapplicable to a particular situation or entity. Although negative feedback is largely ignored, it will be appreciated that in some embodiments negative feedback can have a negative affect a credibility score, depending on the algorithm(s) applied.

The weighted points of the survey/review are then aggregated into the survey/review portion of the credibility score, which may comprise the entire credibility score of an individual, or only a portion of the credibility score. For example, a credibility score can be created for a particular entity based on the survey/review portion of the credibility score, as well as any other predetermined scoring criteria. Such criteria can include considerations regarding a level of credibility being applied for as well as the completion of requirements for a particular type of a credibility score being sought. For example, different credibility standards and levels may require different scoring algorithms to be applied in addition to the initial scoring algorithm(s) that are applied to the survey/review data. Various other feedback received from respondents can also be analyzed and used to calculate a final credibility score, as can the completion of particular requirements. For example, endorsements, certifications, and other requested data can be scored and applied as points to the final credibility score of a particular entity.

Analyzing the data can also include waiting until a minimum number of surveys/reviews or questions are completed or until a minimum amount of survey/review data is received prior to computing or providing a credibility score for a particular member or for a particular credibility ranking, to ensure that the subjectivity of the credibility related information is within an acceptable range, as reflected by the discussion presented above with reference to FIG. 8.

Various follow-up surveys/reviews can also be used, from time to time, to refine or supplement the previously supplied survey/review data. The follow-up survey/review data can also be scored, weighted and applied to an algorithm to help obtain a final credibility score. It will be noted, in this regard, that various analysis processes will be iteratively repeated, as necessary or desired, to compensate for new data and to improve the accuracy of the credibility scoring. For example, it is possible for a respondent to change an answer that was previously provided in a survey/review. Such a change can occur in a follow-up survey/review or in response to the respondent proactively providing new and updated information to the credibility engine through the one or more interfaces provided by the credibility engine. The changed data can either augment or replace existing and stored credibility data. To encourage additional feedback, the credibility engine can automatically remind and request respondents to provide updated information when it becomes available and/or to complete previous or new surveys/reviews. To further encourage participation by the respondents, incentives (including credibility points) and compensation can be provided to the respondents for completing a survey/review, and irrespective of the perceived substance provided by their participation and feedback.

Once a member's credibility score is created, the score can be published or provided (1050) to any number of interested parties, such as to the member or to any other information requesters, such as the information requestors 140 of FIG. 1, and according to any predetermined criteria. For example, the credibility score may be keep confidential, provided only upon request, provided only to the member for whom the score was created, and/or published on a website for anyone to see or according to any other desired criteria.

Attention will now be directed to FIG. 11, which illustrates a flowchart 1100 of an embodiment for creating/modifying a member's network credibility score. Some of the processes described in reference to FIG. 11 will also rely on FIG. 7, which illustrates two credibility networks.

The first act illustrated in the flowchart 1100 of FIG. 11 is the act of receiving a request to develop or modify a member's credibility network (1110). A credibility network is a network of associations that have each been linked together by the credibility engine. The linked members can be members of a club, members of an inner circle, members of a business or another organization, friends, peers, family and/or any other members (including any entities reflected in the chart of FIG. 2B). According to some embodiments, the credibility network is excluded to members who have received a credibility score (vetted members) or to members having a particular credibility ranking/status.

According to some embodiments, certain credibility networks can also receive special designations/rankings corresponding with the amount of members in a network and the scores associated with the members in the network. In this manner, members are encouraged to qualify for membership to different networks and to expand their own networks, so as to belong to a verified credibility network. According to some embodiments, a member can participate in several credibility networks and can even be the root node of more than one credibility network. For example, a member might have one network for business, one for politics, one for social events and so forth.

The request to modify a credibility network can come from a member trying to add another entity to the member's network or, alternatively, a request from the member to join another network that is associated with the entity. The request can also comprise a request to remove an entity from a member's existing network or for a member to be removed from another network.

The next illustrated act is the act of modifying the member's credibility network, when appropriate (1120). The determination as to what is appropriate can be based on communicating with the member and the entity joining the network to make sure there is a mutual agreement regarding the modification of the network. It is also appropriate, in some circumstances, to query all interested parties (all members or a select number of members in the relevant network) to verify that an impending or suggested change to the network is acceptable and prior to executing the change. In some instances, the appropriateness of modifying membership in a credibility network will be a decision that is voted on by all or, alternatively, fewer than all members of the network, and in which a majority or, alternatively, unanimous support might be required.

In some instances, the request (1110) and modification (1120) of a network can occur automatically, when one or more members satisfy or fail to satisfy predetermined criteria. For example, a credibility network carrying a special designation associated with a particular credibility score or credibility requirement can automatically drop members failing to maintain an appropriate score or failing to comply with other requirements. The same network might also automatically add a new member who satisfies certain criteria, even without a request being made by the member. For example, a business having several employees and a corresponding credibility network can automatically add members from that business to the business credibility network once the members receive their scores or satisfy other predetermined criteria.

The final act illustrated in FIG. 11 is the act of creating/updating a member's credibility score. To clarify how this occurs, attention will now be directed to FIG. 7.

As shown in FIG. 7, Member A has a corresponding credibility network that includes Member B 712, Member C 714, Member D 716, Member E 718 and Member F 720. The network of Member A is illustrated by the by the solid lines extending from Member A to each of the other members in Member A's credibility network. As further reflected by FIG. 7, each member with Member A's network has a corresponding credibility score that has been created according to the processes described above, particularly in reference to FIG. 10. By way of example, the individual credibility score of Member A is 116 and the individual credibility score of Member B is 89.

According to one embodiment, Member A's credibility is defined by both Member A's individual credibility score (e.g., the score of 116), as well as Member A's credibility network score. The credibility network score for Member A is created by adding together all of the credibility scores of all members in Member A's network. In this instance, the credibility score of 116 for Member A, the credibility score of 89 for Member B, the credibility score of 132 for Member C, the credibility score of 151 for Member D, the credibility score of 162 for Member E and the credibility score of 121 for Member F are all added together to get a combined network score of 1171. In this regard, the potential value of a member's network credibility score can be viewed as essentially boundless, just like their own individual credibility score.

It will be noted, however, that the network score for Member A will not necessarily be the same as the network score for each other member in Member A's network. The reason for this is that each member will have the ability to define their own networks. In some embodiments, for example, a member may limit their network to only those other members that they feel are within their inner circle or that they trust or that they believe will vouch for them. One reason for this is that the credibility engine can require that members in a network are willing to vouch for or provide information regarding a particular member on request. Due to this requirement, some members may be willing to add the same entities to their networks. For example, Member A and Member C might not be willing or able to add the same other members to their own credibility networks.

Discrepancies between Member A's network and Member C's network are illustrated by the definition of Member C's network, which includes all members linked together by dotted lines (consisting of Member C (714), Member E (718), Member F (720), Member G (730), Member H (732), Member I (734), Member J (736) and Member K (738)), and as compared to Member A's network, which is defined by all members linked together by solid lines (consisting of Member A (710), Member B (712), Member C (714), Member D (716), Member E (718) and Member F (720)).

In view of the defined scope of Member C's credibility network, it will be noted that Member C's credibility score is 988 which comprises the total sum of all credibility scores of all members within Member C's credibility network (132+162+121+119+98+141+124+91=998).

By combining all credibility scores into a single score, members are encouraged to develop and expand their networks to increase their scores. This is very useful for improving communication and networking among professionals and other entities. This can also help improve the accuracy of the scoring, as each member in a network may be required to provide credibility related information (completed surveys/reviews and other data) for each member that is in their network or for each member whose network they belong to.

According to some embodiments, a member is also rewarded with credibility points when their credibility network (e.g., network of other members having credibility scores) has not changed more than one person out of a predetermined number (such as 10 or another number). The bonus points can also be awarded for every member that has remained in their network for a predetermined period of time. This will encourage useful management skills to maintain the stability of the member's network.

However, in order to promote network diversity, and to guard against certain groups of members from joining exactly the same groups, algorithms can be applied to the network credibility scoring modules so that they only include the scores of a predetermined number of members that are shared between two or more networks having common members in each network. For example, if a rule was established that members could only beneficially share two common members then, with respect to the example of FIG. 3, Member A and Member C would only be able to include the individual credibility scores of two of the three common members identified in their networks (including Member C, Member E and Member F). This would result in a reduction of Member A's and Member C's network credibility scores by at least 121 (the smallest credibility score that might have to be sacrificed, namely, the score of Member F).

Other rules and criteria can also be established to satisfy and accommodate any desired need and preference and to encourage certain networking behaviors between the members.

As a final note with regard to FIG. 11, it will be appreciated that a member's credibility network score is a dynamic score that will be updated and modified as members are added or deleted from the member's network and as the network scores of each member within the network change. The changes in the score can be updated immediately upon receiving new updated credibility information or membership data or periodically (e.g., at a certain time every day, week, month or other interval).

According to some embodiments, the network score can also be a complex score that considers and applies the individual and/or network scores of any members that are at all linked to a particular entity in any manner. For example, according to some embodiments, the credibility score of Member K can also be applied to the network score of Member A through a derivative and weighted algorithm that considers the scores of all members linked to members within an entities network.

Attention will now be directed to FIG. 12. FIG. 12 illustrates a flowchart 1200 of elements for using credibility information and credibility networks. As shown, a request is received regarding a member (1210). This request can be a request for information about a member that is received from a third party (such as an information requestor of FIG. 1), the member or any other party (e.g., a clearing house or government agency). Typically, the request will be a request for a credibility score. However, the request can also be a request from a first member for a second member to complete a survey/review, for example about the first member.

After the request is received, the credibility engine will obtain the member data (1220). When the request is for the completion of a survey/review or for other credibility related information to be used in creating or updating another member's credibility score, then the request can be processed and sent to the appropriate parties. For example, a member can request that other members in their network provide information. The credibility engine can initiate communication to the other members and request and follow-up on the request for information until it is received. Once the data is received, it can be provided to the member (if it is not confidential). If the data is confidential or anonymous data, such as certain survey/review data, then the act of providing member data (1230) is completed by providing an updated credibility score that was calculated with the updated data or by advancing the member's credibility status as otherwise determined to be appropriate in view of the data.

Alternatively, if the member data is a credibility score, it can be provided to the requesting party (1230) when access to the score is approved or when appropriate authorization for the score is verified. This may require notification to and approval from the member whose score is being accessed. According to some embodiments, a requesting party must also pay for access to a credibility score and/or other credibility related information aggregated, analyzed and stored by the credibility engine.

It will be appreciated that the credibility scores can be used in an objective manner by various requesting parties to verify initial assumptions made during hiring or investment due diligence procedures. This can save time and reduce the risk on the part of employers and investors. It is also envisioned that the credibility scores will also be used by members as a means for qualifying for certain benefits or awards within a professional environment.

FIG. 12 is also a helpful illustration for understanding embodiments of the invention in which third party can request (1210) and obtain (1220, 1230) information that identifies a member that has a credibility profile that matches a predetermined template profile. In particular, the third party can develop a desired credibility profile, by completing survey/review data that satisfies their requirements of a desired credibility. The credibility profile will basically comprise ranges or values that are determined to be acceptable for certain predetermined credibility attributes. The desired credibility profile can then be provided as part of a request for member information (1210) and to be compared by the server/engine with any number of existing member credibility profiles and/or scores to identify/obtain (1220) the one or more members that most closely match the desired credibility profile. This can occur for example, by having the server/engine compare the values or rankings of the various members with the values that have been preset for the desired credibility profile.

Attention is now directed to FIGS. 13 and 14, which illustrate some examples of interfaces that can be used to provide and view credibility related information.

In FIG. 13 an interface 1300 is provided for providing credibility related information about a particular entity. In particular, the interface 1300 comprises an online survey or review to be completed for a particular entity. The name of the entity will preferably be provided to the person completing the review at location 1310. In some embodiments, however, the name location 1310 is originally left blank, to be search for a name of a particular entity already associated with the credibility network.

As mentioned above, the survey/review questions can be modified to sixteen different attributes 1320 are listed as part of a customized 360° Review™ template. Each of the attributes 1320 is listed along with seven selectable buttons, numbered 1-7. These buttons are selectable by the respondent to reflect the perceived association of the listed attribute with the person being evaluated on a 7 point Likert scale. In one embodiment, a 1 equates to a worst value of “little to none at all” and a 7 equates to the best value of “extremely high”. It will be appreciated, however, that different values and significance can also be associated with virtually any ranking system.

In some embodiments, the calculation of a credibility score and the value of a particular review/survey will depend at least in part on a weighting of the relationship between the respondent filling out the review and the person being reviewed. Information defining the relationship can be obtained with the review, such as in section 1330, by listing various possible relationship types. Selectable buttons can also be provided to enable the respondent to clearly identify the relationship. Other data fields can also be provided to get additional or different relationship information.

Once the review/survey is completed, it can be submitted and considered in the calculation of the credibility score of the person being evaluated, as described throughout this paper.

FIG. 14 illustrates another embodiment of an interface 1400 that can be used in the application of credibility scoring embodiments. As illustrated, the interface 1400 includes various credibility information already extracted and calculated for a particular entity. For instance, the credibility information includes a credibility score 1402, profile information and corresponding level information 1406. The profile and level information correspond to specific requirements for advancing through different levels of a credibility hierarchy. In the present example, the hierarchy includes 5 levels. The requirement for advancing from one level to the next is the receipt of 10 completed reviews, such as the 360° Review™ illustrated in FIG. 13, and described above. In other embodiments, the requirements for advancing to different levels include the receipt and/or completion of other information instead of or in addition to the 360° Reviews™, as generally described above in reference to FIGS. 4A-6B and FIG. 9.

With specific regard to the level and score of a particular member, it will be appreciated that additional information can also be viewed by drilling down to additional interfaces through one or more menu options or selectable buttons. For example, the complete score history button 1410 can be selected to access a display of additional information, even a full complete history or related information, that is used to calculate a member's credibility score or level.

In the present illustration, interface 1400 also includes a summary or dashboard view of certain information, such as the review/survey information 1420 received for a particular member. In this illustration, for example, 155 reviews have been sent out over the last 12 months, 45 of which have been completed, with 15 being completed by primary references and 30 being completed by non-primary references.

Additional profile information can also be displayed, including a member's picture and login history, as shown at location 1430. Other professional information 1440, peer information 1450 can also be displayed to summarize and provide context for the member's credibility evaluation. A notification section 1460 can also display invitations or other notifications for a member to respond to or to obtain information

Various interface tools can be used (such as interface elements 1470) to invite others to perform a review or survey for the member. For example, a member can enter the email address, phone number or mailing address of a potential respondent and then select a submit button or invite button to initiate the transmission of an invitation to the respondent.

A member will preferably invite a significant number of other peers to complete an evaluation, survey or review about the member. One reason for this is so that a more accurate analysis of the member can be made. As previously discussed above, the completion of reviews, surveys and/or assessments is relatively important, inasmuch as the feedback received from these types of information gathering techniques will be used to create a credibility profile and score.

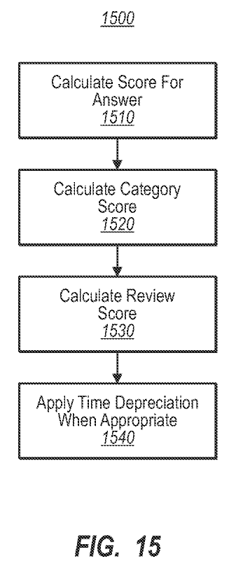

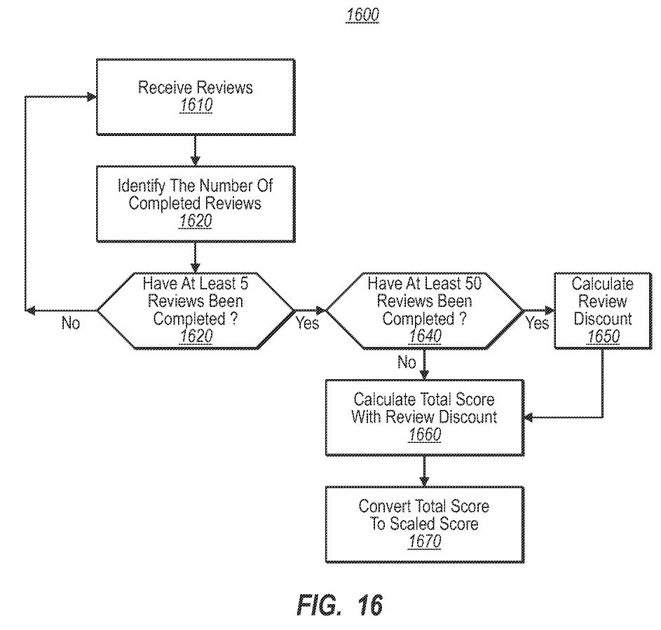

Some techniques and methods for calculating the credibility score from the completed reviews and surveys are described above in reference to FIGS. 4A-6B. However, it will be appreciated that those techniques are not the only techniques that can be used. To further emphasize this point, attention will now be directed to FIGS. 15 and 16, which illustrate other techniques that can be used instead of or in combination with any of the previously discussed techniques for calculating a credibility score.

FIG. 15, for example, illustrates a flow diagram of various processes or acts that can be performed in calculating the score for a particular review, such as the 360° Review™ referenced above. As illustrated, the first process includes calculating a score for a particular answer within the review (1510). In some instances, this calculation includes subtracting the mean point value from the submitted value for a question. For example, if the question queries the value of a person's accountability (on a scale of 1-7, with seven being the best and 1 the worst) then the mean is 4. If the submitted answer for that question is a 6, then the mean value of 4 is subtracted from the 6 point value, resulting in a 2 point value. That 2 point value is then, in some embodiments, multiplied by a weight assigned to that question or attribute. As discussed above, the calculation of the credibility score can be tuned to accommodate different needs and preferences. One way of doing this is by tuning the weights of the different questions presented in the reviews/surveys.

The next illustrated process calculates a category score (1520). A category can correspond with one or more different questions. The category can also be associated with different weights. Accordingly, the calculation of a category score (1520) can include the multiplication of the category weight with a sum of all the answers scores corresponding to that category.

Next, a total review/survey score is tallied by multiplying the category score with a relationship weight, wherein the relationship weight is a weight based on a type of relationship the evaluator/respondent has with the person being evaluated. Different weights for different types of relationships can be assigned to tune the credibility scoring algorithm as desired.

Finally, if additional tuning is desired and/or if it is appropriate, time depreciation is applied to the total review score (1540). According to one embodiment, the time depreciation is applied once it is determined the review is older than 12 months. In other words, after a review has been completed, the review value will begin to be depreciated or discounted after 12 months, such that reviews that have been completed within less than the last 12 months will have more weight and value in the ultimate credibility score than reviews that have been completed more than 12 months ago. It will be appreciated that the depreciation can be a logarithmic or exponential depreciation or, alternatively, a linear depreciation. The depreciation can also be a fixed one time or (n) time depreciation, or any other type of depreciation.

While a single review can provide some basis for a credibility score, it is anticipated that multiple reviews will be needed provide the desired accuracy in analyzing a person's credibility. According to one embodiment, and based on some studies conducted by the inventors, it has been determined that 50 reviews provide a desired level of accuracy with minimal margin of error and that at least 5 reviews are needed to minimize the margin of error to a sufficiently desired tolerability. Accordingly, it is desired that at least 5-50 reviews be completed. To incentivize the member to obtain the desired number of reviews, advancement to the highest level in the credibility network will be dependent upon the receipt of at least 50 completed reviews, with advancement between each level corresponding directly and responsively to the completion of 10 reviews.

The embodiment for calculating a credibility score illustrated in FIG. 16 is based on the receipt of at least 5 reviews and preferably up to at least 50 reviews. However, it will be appreciated that different values can be used, other than the 5 and 50 count, as desired, and to tune the credibility algorithm within a desired tolerance of error.

As illustrated in FIG. 16, the first illustrated process or act is receiving reviews (1610). These reviews can be received through the mail, through the Internet (such as through a social network or a credibility user interface), over the phone, or via any other medium. Understandably, the process of receiving reviews is an ongoing process that can occur in parallel with any of the other processes disclosed. In fact, it will be appreciated that virtually all of the process can be performed in parallel and in different orders than illustrated. (The same principle is true for the other flow diagrams described in this application as well.)

As some point, a determination is made as to the number of completed reviews that have been received (1620). This determination will preferably, although not necessarily, exclude certain reviews from consideration. For example, if multiple reviews have been received from one party for the same individual, then the process will optionally exclude all but the most recently received review. One way to filter through multiple submissions and to exclude all but the latest review is to consider the email address associated with the respondent on the review, such that only one review is considered valid from a particular email address for any one person being evaluated. The submission of multiple reviews from a single respondent is anticipated to be a frequent occurrence, particularly within embodiments that apply time depreciation to the reviews, inasmuch as the respondent will be invited to complete new and/or updated reviews to replace the previous review(s).

In some embodiments, a determination is also made to exclude previously completed reviews that are now too old to be considered valid, even when only a single review has been received from a particular party. Other reviews are excluded, in some embodiments, for other reasons as well (e.g., detected gaming, special requests, and so forth).

According to one embodiment, as mentioned above, it is preferred for at least 5-50 reviews to be received prior to calculating a credibility score, so as to minimize the margin of error in within the calculation of an accurate credibility score. It will be appreciated, however, that different minimum and maximum review criteria can also be applied to satisfy virtually any desired need and preference.

After determining that at least 5 reviews have been received (1620) it is determined whether at least 50 reviews have been completed (1640). If more than 50 reviews have been received, an appropriate review discount is calculated. This review discount will be applied during the calculation of the total review score (1660) to incrementally reduce the benefit of obtaining more than 50 reviews. This way some members will be incentivized to target the 50 peers that will provide the strongest reviews. This can also level the playing field, in some regards, by helping to prevent gaming in situations were a member might be tempted to have all contacts within a social network complete a review, even though those contacts do not know the member that well.

Although different techniques can be used to calculate a review discount, the present example uses a formula comprising (50 or the preferred maximum review count) divided by the (actual reviews completed). If less than 50 reviews are received the review discount does not have to be calculated, it is automatically assigned a value of 1.

The calculation of the total review score (1660) is then performed by subtracting [the product of (the average review score) multiplied by (the biasing review discount of 1 or the calculated review discount)] from [the average review score].

The average review score, which has not specifically been addressed thus far, is calculated by multiplying (the total number of questions provided within each review) by (a calculated average answer value, which is an average value of each answer after considering and applying weighting of the specific question/answer). The average review score may multiply/apply any relationship weighting and category weighting that is appropriate.

Another technique for calculating the total review score (1660) is to simply sum the total value of each individual review (as calculated in FIG. 15, for example), and by multiplying that total value to any appropriate biasing review discount (if more than 50 reviews are included, for example).

Once the total review score is calculated (1660), the method includes converting the total review score to a scaled score (1670) or normalizing the score within a predefined range. According to one embodiment, the total review score is scaled by adding 1000 to a product of dividing (the total review score) by (a maximum total score value that has been divided by 1000). According to one embodiment, the maximum total score value is 480000 (which is equivalent to a maximum score per review of 9600 multiplied by the preferred review count of 50). (The maximum score per review of 9600 is also equivalent to the product of [(the maximum number of questions per review (which is 16 according to the 360° Review™ example)] multiplied by [the sum of 7 minus 4, with 7 being the highest value in the 360° Review™ and 4 being the mean score value for each question] multiplied by [the maximum weighting based on a relationship type (which is 20 in one embodiment)] multiplied by [the maximum weighting based on a category type (which is 10 according to one embodiment)].

The foregoing example was included to provide context for one example of scaling a total review score to a 2000 point scale. It will be appreciated, however, that various other techniques can also be used to scale the score appropriately, and within any desired range.

Once the total review score is scaled, it is presented as the member's credibility score. This score can be kept a secret or published. According to some embodiments, the score is comparatively used as an evaluation tool. In addition to calculating a credibility score, the credibility engine can also identify which attributes a member scores the highest and lowest with. Additional credibility profile and pattern data, which is obtained from the evaluation of the credibility reviews and surveys, can also be identified, published, tracked and/or compared.

By identifying members that match a preferred or known credibility profile or score, it is possible to expedite many hiring processes. It is also possible to use these types of comparative techniques to evaluate existing employees and to make or recommend promotions and bonuses based on the credibility scores and profiles of the various members.

In fact, it will be noted that salaries and other compensation structures awarded to an employee can also be based on the comparative credibility scores earned by the employees according to the embodiments of the invention. In this regard, it will be noted that the creation and use of credibility scores and rankings can also be used as an industry standard in defining a reliable and comparatively accurate real marketplace valuation tool for virtually any type of employee and in virtually any industry. Accordingly, it is envisioned, that companies will accept the credibility algorithm described above (or a derivative thereof) as an industry standard or, alternatively, tune the credibility scoring algorithm in a customized way to more heavily weight attributes and criteria that are determined to be critical and important for the particular companies and such that an evaluation of all employees with the tuned credibility scoring algorithm will result in a comparative measure as to the market worth of the employees for the companies.

Once adopted as an industry or company standard, the credibility algorithm and scoring embodiments of the present invention can thus be used to track the real and/or perceived comparative marketplace value of the different employees within the particular company or industry.

In one embodiment, for example, the adoption of this industry standard will enable employees and other members of the public to be rated and valued almost in the same way that a branded commodity is rated and valued in the commodities marketplace. In particular, employees will become associated with comparatively distinguishing scores that will enable the employee's services and contractual employment to be bid for in the open marketplace, similarly to how commodities are traded, and such that a corresponding stock value will be assigned to each employee that will fluctuate with the demands of the marketplace and the corresponding valuation of the employee based upon their credibility score(s).

According to one embodiment, the credibility scores of the various members will be displayed on an interface (which could include a stock-type ticker, or a trading interface, for example) and through which the member's services can be bid upon based upon the comparatively displayed supply of credibility scores of credibility network members and the market demand for such members as potential employees.

In view of the foregoing, and as mentioned before, it will be appreciated that the references to the credibility scoring should be broadly interpreted as applying to various types of attribute scoring methods and techniques, unless otherwise restricted by their description in the claims, and so as to include such things as reputation scoring. It will be noted, however, that many of the credibility scoring embodiments clearly exclude, or can be modified to exclude, any consideration of explicit economic considerations, such as those considered in credit scoring.

While economic credit scores already exist and have provided a significant benefit to investors and loan officers, in evaluating potential risk, there has been no satisfactory and suitable means for verifying and objectively scoring credibility of an individual or entity (particularly with regard to character and competence). The embodiments of the present invention, however, can be used as a means for verifying and objectively measuring credibility and for providing a credibility score.

Accordingly, it will be noted that the embodiments of the invention are clearly distinguished from, or can be modified to be distinguished from, credit scores that are used by financial institutions. In particular, while existing credit scores consider economic risks, the credibility scores of the present invention consider the various attributes and characteristics that are associated with credibility (including character and competency attributes which exclude or that can be selected to exclude the economic considerations that are used in the creation of credit scores).

In view of the foregoing, it will be appreciated that the embodiments of the present invention are not only new and unique but useful. It will also be appreciated that the scope of the invention extends beyond the specific examples provided above, inasmuch as there are many other permeations and alternative embodiments that fall within the scope of the present invention for creating and using credibility scores. Accordingly, while specific embodiments have been illustrated and described, these embodiments are to be considered in all respects only as illustrative and not restrictive. Furthermore, while the foregoing subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Inasmuch as the present invention may be embodied in many other specific forms without departing from its spirit or essential characteristics, the scope of the invention is, therefore, indicated by the appended claims rather than by the foregoing description. All changes which come within the meaning and range of equivalency of the claims are to be embraced within their scope.

What is claimed is:

1. A method for a computing system comprising a computerized credibility engine to create an individual credibility score that is distinguished from a purely economic credit score and which can be used to objectively rate a comparative value of credibility for a particular entity, the method comprising:
the credibility engine receiving a request for membership for an entity;
the credibility engine identifying contacts associated with the entity;
the credibility engine gathering credibility related information associated with the entity from one or more information sources;
the credibility engine analyzing the credibility related information and calculating a corresponding credibility score by identifying values associated with the credibility related information and by inputting the values into a credibility scoring algorithm which is configured to weight information provided by information providers based at least in part on a relationship of the information providers; and
the credibility engine providing the credibility score to one or more information requestors.

2. A method as recited in claim 1, wherein the entity comprises an individual.

3. A method as recited in claim 1, wherein the entity includes at least one of a business or an organization.

4. A method as recited in claim 1, wherein the act of identifying contacts associated with the entity includes receiving information from the entity that identifies the contacts and that further includes contact information corresponding to the contacts.

5. A method as recited in claim 1, wherein the request for membership for an entity comprises a request to obtain the credibility score for the entity.

6. A method as recited in claim 5, wherein the request for membership is received from the entity.

7. A method as recited in claim 1, wherein the act of the credibility engine gathering credibility related information associated with the entity from one or more information sources comprises the credibility engine providing surveys or reviews to the one or more information sources and wherein the surveys or reviews include questions regarding credibility about the entity.

8. A method as recited in claim 7, wherein the one or more information sources include the contacts associated with the entity.

9. A method as recited in claim 7, wherein the act of the one or more information sources include primary and secondary sources and wherein the credibility engine gathering credibility related information includes the credibility engine distinguishing between primary sources and secondary sources, with information provided by primary sources being awarded a greater weight than information provided by secondary sources and wherein the primary sources include at least one of a client or an employer and whereas the secondary sources include at least one of a friend, an employee, a co-worker or family member.

10. A method as recited in claim 1, wherein the act of the credibility engine analyzing the credibility related information and calculating the corresponding credibility score includes weighting scores associated with questions presented to the one or more information sources and summing the weighted scores into a final score comprising the credibility score.

11. A method as recited in claim 1, wherein the method further includes an act of combining the credibility score with at least one credibility score of another entity to create a network credibility score associated with the entity.

12. A method as recited in claim 1, wherein the method further includes providing a credibility ranking for the entity, which is distinguished from the credibility score, and upon determining that certain predetermined criteria have been established.

13. A computer program product comprising one or more computer-readable storage media having computer-executable instructions for implementing the method recited in claim 1.

14. A computer program product as recited in claim 13, wherein the computer program product comprises a computing system and wherein the one or more computer-readable storage media comprise system memory.

15. A computer program product as recited in claim 14, wherein the computer program product comprises a plurality of computing systems and wherein the one or more computer-readable storage media comprises system memory distributed between the plurality of computing systems.

16. A computer program product as recited in claim 13, wherein the member is only one of a plurality of members and wherein the method further includes:
identifying, for each of the plurality of members, a credibility score that is distinguished from a purely economic credit score and which can be used to objectively rate a comparative value of credibility for each of the plurality of members;
linking at least two members of the plurality of members into a credibility network; and
summing the credibility score of each of the at least two members into a network credibility score.

17. A computer program product as recited in claim 16, wherein the linking of the at least two members into a credibility network is performed at the specific request of at least one of the members.

18. A computer program product as recited in claim 16, wherein the recited method further includes identifying a modification of at least one credibility score corresponding to one of the at least two members and thereafter responsively modifying the network credibility score.

19. A system for providing a credibility score that is distinguished from a purely economic credit score and which can be used to objectively rate a comparative value of an entity, the system comprising:
data storage; and
a computerized credibility engine configured to implement the method recited in claim 1.

20. A method for calculating a credibility score for an entity, the method comprising:
identifying credibility attributes associated with an entity;
associating a value with each of the attributes; and
using a computing system to calculate a credibility score of the entity from the credibility attributes.

21. A method for enabling the bidding for the services of entities based upon calculated credibility scores of the entities, the method comprising:
using a computer to identify a credibility score of an entity, which is a calculated credibility score based on credibility attributes of the entity and a predetermined credibility scoring algorithm; and
using the computer to provide an interface for displaying the credibility score of the entity and for receiving a bid associated with the services of the entity.

22. A method for using a credibility scoring algorithm to identify a preferred credibility profile and to identify an entity matching the preferred credibility profile, the method comprising:
using a computer to identify a credibility scoring algorithm configured to calculate a credibility score based on credibility attributes of at least one entity;
using a computer to provide preferred credibility attribute data as input into the credibility scoring algorithm to identify a preferred credibility score; and
using a computer to use the credibility scoring algorithm to calculate a credibility score for at least one entity that is within a preferred range of the preferred credibility score.

23. A method for tuning a credibility scoring algorithm, the method comprising:
using a computer to identify a credibility scoring algorithm configured to calculate a credibility score based on credibility attributes of at least one entity;
using a computer to tune elements considered in the credibility scoring algorithm to adjust how the credibility scoring algorithm calculates the credibility score of said at least one entity.

24. A computerized interface for accessing a credibility score, comprising:
a first interface element that can be selected to responsively display a credibility score associated with credibility attributes of an entity and that is calculated using the credibility attributes and while excluding financial attributes used in calculating a financial credit score;
at least one interface element that can be selected to provide or access information that is used to calculate the credibility score.
